(19) United States
(12) Patent Application Publication
(10) Pub. No.: US 2020/0258048 A1
(43) Pub. Date: Aug. 13, 2020

(54) SYSTEM FOR IDENTIFYING MENTAL MODEL ORIENTATIONS OF AN INDIVIDUAL

(71) Applicant: Idea Connection Systems, Inc., Rochester, NY (US)

(72) Inventor: Robert Bernard Rosenfeld, Rochester, NY (US)

(21) Appl. No.: 16/858,500

(22) Filed: Apr. 24, 2020

Related U.S. Application Data
(63) Continuation-in-part of application No. 29/660,291, filed on Aug. 20, 2018, now Pat. No. D885418.
Application No. 29/660,291 is a continuation-in-part of application No. 15/280,901, filed on Sep. 29, 2016, now abandoned.
Application No. 15/280,901 is a division of application No. 14/716,430, filed on May 19, 2015, now abandoned.
Application No. 14/716,430 is a continuation of application No. 13/834,890, filed on Mar. 15, 2013, now abandoned.

(51) Int. Cl. G06Q 10/10; G09B 7/10; G06Q 90/00; G09B 7/06

(52) U.S. Cl. CPC G06Q 10/1053; G09B 7/06; G06Q 90/00; G09B 7/10

(57) ABSTRACT

A system for identifying predictive indicators of behavior of a user and demonstrating the predictive indicators of behavior in a graphical manner, the system comprising an input apparatus to facilitate recording of answers to a plurality of groups of questions from the user, a processing apparatus to facilitate calculation of output parameters, each of the output parameters are calculated by averaging answers to each of the plurality of groups of questions and a graphical apparatus to display the output parameters of each user in a graphical format, wherein each of the output parameters is depicted as its affinity to two diverse poles reflecting cognitive, affective and conative variables that illustrate a person's mental model regarding creativity, innovation, and change.

### PRIORITY CLAIM AND RELATED APPLICATIONS

This continuation-in-part application claims priority to design patent application U.S. Ser. No. 29/660,291 filed Aug. 20, 2018, which is a continuation-in-part application of non-provisional application U.S. Ser. No. 15/280,901 filed Sep. 29, 2016, which is in turn a divisional application of non-provisional application U.S. Ser. No. 14/716,430 filed May 19, 2015, which is in turn a continuation-in-part application of non-provisional application U.S. Ser. No. 13/834,890 filed Mar. 15, 2013. Each of said applications is incorporated by reference herein in its entirety.

### BACKGROUND OF THE INVENTION

### 1. The Field of the Invention

The present invention is directed generally to a system for identifying mental model orientations or predictive indicators of behavior of an individual. More specifically, the present invention is directed to a system for identifying orientations of an individual in which all three aspects of mental functioning, i.e., cognitive, conative and affective are considered.

### 2. Background Art

U.S. Pat. No. 8,317,520 to Swanson (hereinafter Swanson) discloses a system, method and apparatus configured to measure and classify innovation skills and technical capability of individuals based on predefined referenceable attributes. The classification is used to help individuals to improve their innovative abilities and to build innovation teams. The classifications are stored such that they may be further analyzed and used. In Swanson, an instrument for testing the technical capability of individuals is an integral portion. Swanson fails to uncover predictive indicators of behavior that can be used to identify suitable individuals for specific positions both as an individual functioning alone or in a team environment.

As having the right individuals assigned to a project can directly affect the success of the project, businesses have looked to tools which aid them in detecting the characteristics which make individuals suitable for the project. Two aspects of a candidate are key to successful placement in a job: 1. Education, training, skills, experience, and 2. Personal characteristics. While technically-oriented tests and resumes are available for the former, the latter can only be measured by using the available psychological tests and measurements. Current tests measure “aptitude,” “achievement,” “intelligence,” “emotional intelligence,” “personality,” “interpersonal styles,” and various aspects of psychopathology. A standardized test of preferred mental models in regard to innovation and change does not exist. All existing tools lack the ability to identify and integrate an individual's cognitive, conative and affective orientations into a cohesive and easily understood graphic model with detailed explanatory descriptions of their preferred mental model for creating change, relating with others, and solving problems. The invention has at least seven purposes:

1. For individuals to understand themselves—by seeing and appreciating their own mental models by examining their mental model profile, i.e., totem, to understand their strengths and potential blind-spots, their preferred type of change, and the ways they can anticipate interacting with others similar to them and different from them.
2. To create a specific type of innovation needed within an organization or community—by specifying the mental models likely to create this type of change (incremental to breakthrough) and selecting from the pool of available individuals those whose mental models most closely match the desired mental model profile by comparing the ideal totem to the measured totems.
3. To create teams charged with a specific organizational task—by choosing individual team members based on their mental models that maximize their potential for creating the type of change desired in combination with the mental models of the other people on the team.
4. To select leaders within an organization—by specifying the types of leadership needed to foster the appropriate organizational stage of growth (start-up, stabilization, expansion, etc.) and matching the type of leaders needed to the mental models likely to create this type of leadership by selecting from the pool of available individuals those whose mental models most closely match the desired mental model profile as indicated by the ideal totem also known as an Archetype.
5. For promotion or re-assignment of roles within an organization—by specifying the type of role needed to foster the appropriate organizational behavior and matching the mental models likely to create this behavior by selecting from the pool of available individuals those whose mental models most closely match the desired mental model profile as indicated by the ideal totem (Archetype) compared to the measured totems.
6. For hiring purposes—by selecting from the pool of available individuals with the appropriate education, training, experience and technical skills those whose mental models most closely match the desired mental model profile as indicated by the ideal totem (Archetype) compared to the measured totems.
7. To show change within an individual over time or across different situations by repeating administrations of the instrument.

In addition, the resources spent in an interview or vetting process must not be overlooked. Typically, the fewer steps involved, the speedier, more focused and hence less costly it is.

Thus, there arises a need for a system for identifying the mental model orientations of an individual that is simple to conduct and whose result is simple to interpret.

### SUMMARY OF THE INVENTION

The present invention is directed toward a computer system for identifying predictive indicators of behavior of a user and demonstrating the predictive indicators of behavior in a graphical manner, the computer system comprising:
(a) a processor, the processor being a hardware component of the computer system; and
(b) a memory device in communication with the processor, the memory device storing a plurality of instructions that when executed by the processor, execute the steps of:
   (i) providing an interface application, displayed on an electronic device, the interface having selectable options including at least an option to access data comprising a plurality of groups of questions, wherein each of the plurality of groups of questions comprises at least two questions whose answer choices are expressed as their affinity to two diverse poles;
   (ii) in response to a user selection, via an electronic input device, to access the plurality of groups of questions, searching a question database, where the question database stores a plurality of groups of questions, wherein at least two questions of each of the plurality of groups of questions are presented in a non-consecutive manner to at least one other question of the plurality of groups of questions and the at least two questions are related to cognitive, conative and affective brain functions; (iii) accepting an answer to each question of the plurality of groups of questions and recording the answer;
   (iv) calculating output parameters that identify predictive indicators of an individual's neural predisposition for a behavior orientation of the user, where each of the output parameters is calculated by averaging answers to each question in each group of questions, wherein the output parameters comprise the user's ideation, risk, process, the sum of the user's ideation, risk and process, control, relationship, networking, input, flow, passion, output and energy;
   (v) positioning the output parameters as its affinity to the two diverse poles; and
   (vi) comparing each of the output parameters to a predetermined target to result in a gap, wherein if the gap is within a predetermined threshold, the user is meeting the expected behavior orientation for the output parameter.

A typical user takes from about four to about fifteen minutes to answer all fifty questions presented to the user.

In one embodiment, the two diverse poles are “builder” and “pioneer,” “self initiate” and “others initiate,” “concrete” and “visionary,” “converge” and “diverge,” “prudent” and “action,” “heart” and “head” and “self” and “people.”

In one embodiment, the graphical format is a single screen shot. In another embodiment, the graphical format is a single physical printed media.

Each output parameter is presented in a discrete scale representing a spectrum of the two diverse poles in a plurality of boxes. In one embodiment, the number of the output parameters is twelve.

In one embodiment, each of the plurality of boxes further represents three discrete positions or subsections, further refining the use of such boxes to represent a spectrum of representations within each box.

In one embodiment, the number of the plurality of boxes is six. In another embodiment, the number of the plurality of boxes is three.

In one embodiment, the output parameters comprise target answers superimposed on actual answers of the user on one display such that differences between the actual answers of the user can be discerned from the target answers. In addition to indicating the existence of differences between two sets of output parameters, the degree of such differences is also revealed.

In another embodiment, a Change Indicator Map (CIM) is used to indicate differences between the present set of output parameters of a user to a second set of output parameters of the same user at a later time. Again, in addition to indicating the existence of differences between two sets of output parameters, a CIM also indicates the degree of such differences.

Further disclosed is a system for narrowing a pool of candidates for at least one role, wherein a totem is obtained from each individual of at least two favorable individuals for the at least one role, each totem includes a plurality of output parameters each presented in a discrete scale representing a spectrum of the two diverse poles in a plurality of boxes, each output parameter identifies a predictive indicator of an individual's neural predisposition for a behavior orientation of the individual, the system including:

(a) a processor; and
(b) a non-transitory machine-readable storage medium storing instructions that when executed, cause the processor to:
(i) responsive to receiving a recommendation from at least one manager of the at least two favorable individuals, retrieve a totem of each individual of the at least two favorable individuals;
(ii) overlay the totems of the at least two favorable individuals to yield a composite totem representing a favorable archetype, wherein the overlay act is configured to yield a composite output parameter inclusive of the output parameters of the totems of the at least two favorable individuals and any gaps between the output parameters of the totems of the at least two favorable individuals for each predictive indicator;
(iii) obtain a totem from each candidate of the pool of candidates;
(iv) score the totems of the pool of candidates against the composite totem representing a favorable archetype; and
(v) identify at least one of the top scorers for further consideration to fill the at least one role.

In one embodiment, each of the at least two favorable individuals includes a rating. In one embodiment, only any individuals of the at least two favorable individuals having the rating above a predetermined threshold is retrieved. In one embodiment, the totems of the pool of candidates are scored against the composite totem representing a favorable archetype by weighting one or more output parameters of the totems of the pool of candidates.

In one embodiment, a totem is further obtained from each individual of at least two unfavorable individuals for the at least one role, wherein the non-transitory machine-readable storage medium storing instructions that when executed, further cause the processor to:

(a) responsive to receiving a recommendation from at least one manager of the at least two unfavorable individuals, retrieve a totem from each individual of the at least two unfavorable individuals;
(b) overlay the totems of the at least two unfavorable individuals to yield a second composite totem representing an unfavorable archetype, wherein the overlay act of this claim is configured to yield a composite output parameter inclusive of the output parameters of the totems of the at least two unfavorable individuals and any gaps between the output parameters of the totems of the at least two unfavorable individuals for each predictive indicator;
(c) overlay the second composite totem and the composite totem representing a favorable archetype to create a third composite totem including one or more conditions selected from the group consisting of an area not overlapped that represents the favorable archetype, an overlapped area of the favorable and unfavorable archetypes, an uncovered area and an area not overlapped that represents the unfavorable archetype in one or more predictive indicators;
(d) apply weighting to one or more predictive indicators of the third totem, wherein at least one of the area not overlapped that represents the favorable archetype is assigned a first weight, the overlapped area of the favorable and unfavorable archetypes is assigned a second weight, the uncovered area is assigned a third weight and the area not overlapped that represents the unfavorable archetype is assigned a fourth weight; and
(e) replace the score act with an act that scores the totems of the pool of candidates against the third composite totem.

In one embodiment, a totem is further obtained from each individual of at least two unfavorable individuals for the at least one role, wherein the non-transitory machine-readable storage medium storing instructions that when executed, further cause the processor to:

(a) responsive to receiving a recommendation from at least one manager of at least two unfavorable individuals, retrieve a totem from each individual of the at least two unfavorable individuals, wherein the at least two unfavorable individuals are mutually exclusive from the at least two favorable individuals;
(b) overlay the totems of the at least two unfavorable individuals to yield a second composite totem representing an unfavorable archetype, wherein the overlay act of this claim is configured to yield a composite output parameter inclusive of the output parameters of the totems of the at least two unfavorable individuals and any gaps between the output parameters of the totems of the at least two unfavorable individuals for each predictive indicator; and
(c) apply the second composite totem representing an unfavorable archetype to the identify act, whereby if the at least one of the top scorers has an orientation falling within predictive indicator ranges of the second composite totem representing an unfavorable archetype, the at least one of the top scorers is rejected from consideration from filling the at least one role.

Accordingly, it is a primary object of the present invention to provide a system for determining the mental model orientation of individuals in regard to the variables measured that are pertinent to functional behavior within an organization that is simple to conduct and whose result is easy to interpret.

It is another object of the present invention to provide a system for determining orientations whose result can be presented on one hardcopy sheet or one screen shot such that the presented material can be visually analyzed all on one sheet or screen or whose similarities can be easily matched to an ideal totem or whose differences can be easily discerned from an ideal totem.

It is yet a further object of the present invention to provide a system for determining orientations where the answer choices of each question represent the degree of their affinity to two diverse poles, thereby providing users with sufficient but not overly complicated choices to select from.

It is yet a further object of the present invention to provide a system for determining orientations where strong orientations can be identified and ascertained as those closest to two diverse poles, eliminating the peril of selecting individuals without strong orientations when an ideal totem calls for such orientations.

Whereas there may be many embodiments of the present invention, each embodiment may meet one or more of the foregoing recited objects in any combination. It is not intended that each embodiment will necessarily meet each objective. Thus, having broadly outlined the more important features of the present invention in order that the detailed description thereof may be better understood, and that the present contribution to the art may be better appreciated, there are, of course, additional features of the present invention that will be described herein and will form a part of the subject matter of this specification.

### BRIEF DESCRIPTION OF THE DRAWINGS

In order that the manner in which the above-recited and other advantages and objects of the invention are obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a block diagram depicting the process in which a totem is built by starting from data collection.

FIG. 2 is a diagram depicting a means by which the answer to an output parameter is obtained.

FIG. 3 depicts a totem according to the present invention.

FIG. 4 depicts the representation of an individual's orientation in a totem.

FIG. 5 depicts a group of questions whose answers are used to result in a representation of an individual's orientation in terms of ideation.

FIG. 6 depicts a group of questions whose answers are used to result in a representation of an individual's orientation in terms of risk.

FIG. 7 depicts a group of questions whose answers are used to result in a representation of an individual's orientation in terms of process.

FIG. 8 depicts a group of questions whose answers are used to result in a representation of an individual's orientation in terms of control.

FIG. 9 depicts a group of questions whose answers are used to result in a representation of an individual's orientation in terms of relationship.

FIG. 10 depicts a group of questions whose answers are used to result in a representation of an individual's orientation in terms of network.

FIG. 11 depicts a group of questions whose answers are used to result in a representation of an individual's orientation in terms of input.

FIG. 12 depicts a group of questions whose answers are used to result in a representation of an individual's orientation in terms of flow.

FIG. 13 depicts a group of questions whose answers are used to result in a representation of an individual's orientation in terms of passion.

FIG. 14 depicts a group of questions whose answers are used to result in a representation of an individual's orientation in terms of output.

FIG. 15 depicts a group of questions whose answers are used to result in a representation of an individual's orientation in terms of energy.

FIG. 16 depicts an example totem of an incumbent as compared to an example ideal totem.

FIG. 17 depicts an example totem of an incumbent as compared to an example totem of a first candidate.

FIG. 18 depicts an example totem of a first candidate as compared to an example ideal totem.

FIG. 19 depicts an example totem of an incumbent as compared to an example totem of a second candidate.

FIG. 20 depicts an example totem of a second candidate as compared to an example ideal totem.

FIG. 21 depicts an example totem of an incumbent as compared to an example totem of a third candidate.

FIG. 22 depicts an example totem of a third candidate as compared to an example ideal totem.

FIG. 23 is a block diagram depicting one embodiment of the hardware for carrying out the present system.

FIG. 24 depicts examples of archetype roles one or more firms can seek to fill.

FIG. 25 depicts an exemplar set of individuals considered successful in the role a firm is attempting to fill.

FIG. 26 depicts ratings provided by an executive team of a firm of the exemplar set of individuals on how well the individuals match the role the firm is seeking to fill.

FIG. 27 depicts totems collected from an exemplar set of individuals considered successful in the role a firm is attempting to fill.

FIG. 28 depicts a composite totem that is the result of overlaying totems collected from an exemplar set of individuals considered successful in the role a firm is attempting to fill.

FIG. 28A is a partial composite totem illustrating the result of overlaying two partial totems collected from an exemplar set of individuals considered successful in the role a firm is attempting to fill.

FIG. 29 depicts a composite totem that is the result of overlaying totems collected from top rated individuals of an exemplar set of individuals considered successful in the role a firm is attempting to fill.

FIG. 30 depicts negative constraints represented in a composite totem that is the result of overlaying totems collected from individuals who are considered to not perform well in a role a firm is attempting to fill.

FIG. 31 depicts ideal ranges for each of the Innovation Strengths Preference Indicator (ISPI) orientations based on a selected totem for an exemplar set of individuals considered successful in the role a firm is attempting to fill.

FIG. 32 depicts a comparison of the ISPI ranges of an exemplar set against an existing ISPI archetype to determine if the role a firm is attempting to fill can be filled by an individual who fits the existing ISPI archetype.

FIG. 33 depicts weighting of ISPI orientations based on their relevance to the role a firm is attempting to fill.

FIG. 34 depicts a comparison of totems from potential candidates for the role a firm is attempting to fill to an ideal totem.

FIG. 35 depicts a result of scoring each potential candidate for the role a firm is attempting to fill using weighting of ISPI orientations and negative constraints to arrive at a numerical indicator of how closely a potential candidate is in line with the expectation for the role a firm is attempting to fill.

FIG. 35A is a partial composite totem illustrating the result of overlaying two partial totems, one collected from an exemplar set of individuals considered successful in the role a firm is attempting to fill and the other collected from individuals known to managers or executives as not having performed well in the role.

FIG. 36 depicts examples of reports indicating the suitability of potential candidates with respect to the role a firm is attempting to fill.

FIG. 37 depicts gaps identified in potential candidates with respect to the role a firm is attempting to fill which can be used to further question or coach the potential candidates.

FIG. 38 is a block diagram of an example computing device for narrowing a pool of candidates for at least one role.

### PARTS LIST

2—step in which questions are presented to individuals
4—step in which answers to questions are collected
6—step in which answers are mapped into subsections
8—step in which data points are resolved into 15 user attributes that are displayed on a totem
10—representation of an individual's orientation with respect to an output parameter
12—first box
14—second box
16—small miss
18—big miss
20—input device
22—output device
24—internet
26—web servers
28—central repository
30—monitoring device
32—“human” symbol
34—lower bound
36—upper bound
38—area not covered
40—overlapped area
42—computing device
44—processor
46—machine-readable storage medium
48—network
50—client computing device
52—retrieval engine
54—overlay engine
56—totem generating engine
58—scoring engine
60—selection engine
XB—extreme builder
B—builder
MB—mid builder
MP—mid pioneer
P—pioneer
XP—extreme pioneer

### Particular Advantages of the Invention

The present invention draws on research from all three aspects of mental functioning, i.e., cognitive, conative and affective while a prior art system and method such as Myers-Briggs Type Indicator (MBTI) which was originally derived from Carl Jung's work involving the existence of two dichotomous pairs of cognitive functions, i.e., the “rational” (judging) functions, e.g, thinking and feeling and the “irrational” (perceiving) functions, e.g., sensing and intuition. The result of the present invention is a totem that is easily viewed and interpreted as compared to more complex results such as those found in MBTI involving 16 personality types. The present invention measures a person's orientation or human behavior information rather than his or her capacity. The human behavior information is based on a plurality of personality tests, behavior surveys and behavior expert analysis. With insight into orientations of individuals, teams can be assembled to optimize diversity and team functioning within the organization. Additionally, insight into one's own orientation and behavior patterns can help individuals work effectively with other team members, especially in innovation projects.

By presenting more than one question for each orientation, three or more answer choices for each question and answer choices that are disposed between two diverse poles, a user's orientation can be ascertained, especially if an answer falls on one of the two diverse poles, indicating a strong preference for such pole. In addition, in order to identify a suitable candidate for a position, it is a matter of matching the candidate's totem with an ideal totem drawn up for the position. In order to fill a position requiring an orientation complementary to an established totem, it is a matter of computationally or visually combining a candidate's totem with the established totem.

Further, by creating and utilizing archetypes derived from within an organization, the organization becomes better able in shortlisting candidates that are considered suitable for the organization instead of merely using ideal archetypes which may not represent candidates with desired orientations for the roles the organization is attempting to fill.

### DETAILED DESCRIPTION OF A PREFERRED EMBODIMENT

The term “about” is used herein to mean approximately, roughly, around, or in the region of. When the term “about” is used in conjunction with a numerical range, it modifies that range by extending the boundaries above and below the numerical values set forth. In general, the term “about” is used herein to modify a numerical value above and below the stated value by a variance of 20 percent up or down (higher or lower).

The Innovation Strengths Preference Indicator (ISPI) is an “indicator” of one's orientations or pre-dispositions for taking a specific approach to being innovative and looks at twelve unique “orientations” that affect how people prefer to approach innovation as well as working with others on a team to do so. The ISPI draws on research from all three aspects of mental functioning, i.e., how people think (cognitive), take action (conative), and meet their personal relational needs (affective), mapping all three brain functions in just one indicator, effectively creating a snap-shot of an individual's internal working mental model in regard to change.

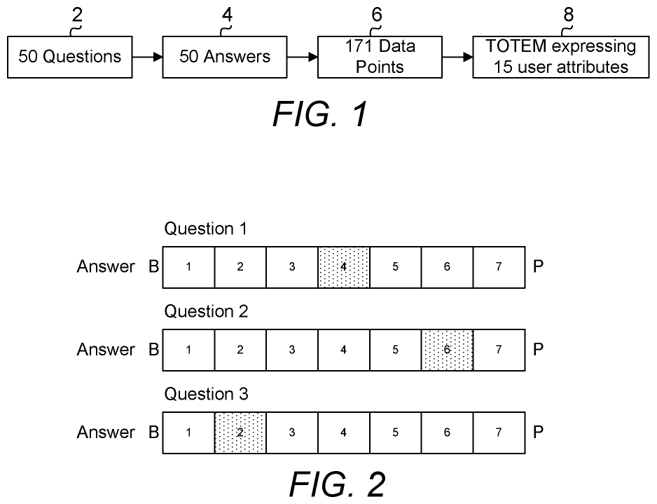

FIG. 1 is a block diagram depicting the process in which a totem is built by starting from data collection. A set of fifty questions is first presented to a user or survey taker as in step 2. As used herein, the questions may be presented in the form of text or images. Each question includes at least three answer choices related to one of twelve orientations or characteristics. Upon receiving an answer to each of the fifty questions as in step 4, these answers are mapped in step 6 into 171 discrete positions in a totem.

Each discrete position is a subsection, which is further described elsewhere herein. The set of fifty questions and their corresponding answers are divided into several groups, each corresponding to an orientation for a total of fifteen attributes or output parameters. Step 8 depicts a step where the twelve orientations including fifteen attributes are obtained and presented in a totemic format.

FIG. 2 is a diagram depicting a means by which the answer of an output parameter is obtained. In this example, a total of three questions (1, 2 and 3) are used to determine an attribute. The answers to questions 1, 2 and 3 are 4, 6 and 2, respectively. Each answer choice represents a position on a polar graph between two diverse poles or its affinity to one of the two diverse poles, which in this case are represented by “B” for builder and “P” for pioneer. The answer associated with the attribute is the arithmetic average of the answers of questions 1, 2 and 3, i.e., (4+6+2)/3=4. It is also possible to receive a non-whole number as an average. For instance, if the answers had been 4, 7 and 2, the average would have been (4+7+2)/3=4.33. In one embodiment as shown, answer choices range from 1-7 with 1 indicating an attribute most closely approximating “B” while 7 indicating an attribute most closely approximating “P.” In mapping answer choices to a 3-box output parameter, an answer in the range of from 1 to 3 is represented in the leftmost box and an answer in the range of from 5 to 7 is represented in the rightmost box. An answer of 4 is represented in the middle box. For a 6-box output parameter, an answer in the range of from 1 to 3 is represented in one of the leftmost boxes and an answer in the range of from 5 to 7 is represented in one of the rightmost boxes with the lowest number occupying the leftmost box and the highest number occupying the rightmost box. An answer of exactly 4.0 is represented either in the third box from the leftmost box or the third box from the rightmost box as there is not a box to represent the middle point. The decision to place the answer of 4.0 is made based on feedbacks from subsequent interviews with users. If the results from such interviews indicate that the placement has been accurate for a particular output parameter, the placement is left alone. Otherwise, the placement is changed.

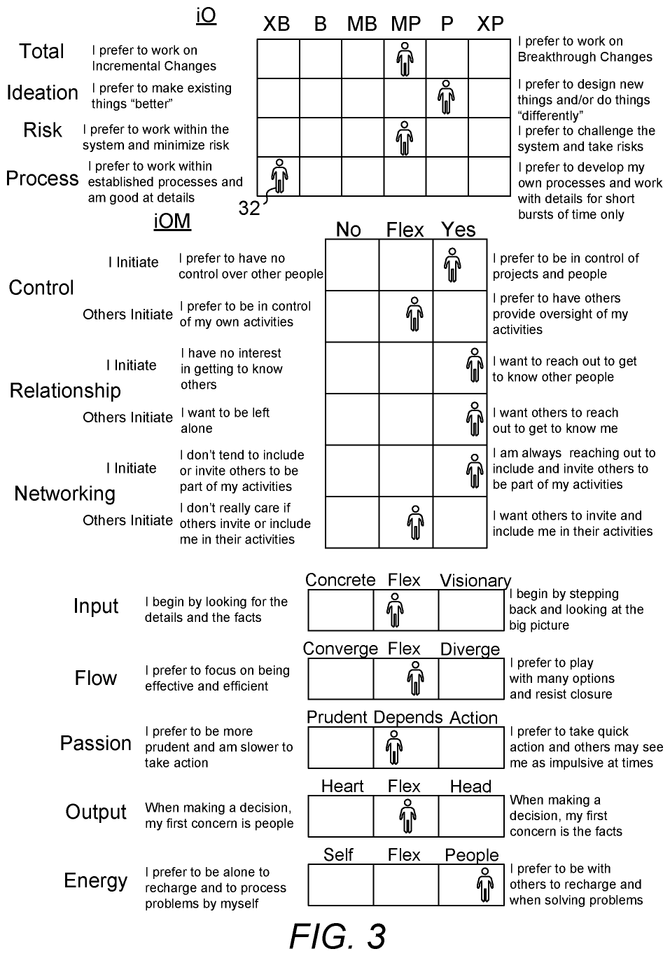

FIG. 3 depicts a totem according to the present invention. The output parameters comprise the following indicia: user's ideation, risk, process, the sum of the user's ideation, risk and process, control, relationship, networking, input, flow, passion, output and energy. It shall be noted that each output parameter is presented in a discrete scale representing a spectrum bounded by two diverse poles in a plurality of boxes. Innovation Orientation theory asserts that people differ in their approaches to problem solving, decision making, creativity, working with others, etc. The ISPI is a measure of orientation, not capacity. It is an indicator of how one prefers to create and innovate and the type of innovation one likes to work on, not one's level of skill. Some individuals will prefer a “Builder” approach to innovation, while others will prefer a “Pioneer” approach. An individual's orientation is neither “good or bad” nor “right or wrong.” Groups require diversity of orientations to optimize their functioning. Each orientation has its own strengths and potential weaknesses. The purpose of the ISPI is to help one understand more clearly one's own and other people's Innovation Orientation (iO) and likely behavior patterns. The ISPI makes visible what is generally invisible to one and others. This, in turn, helps to produce more effective individual and team performance that leads to more successful innovation efforts.

It shall also be noted that the totem is preferably presented on a single physical printed media, such as a piece of paper, etc. or on a single screen shot, such as a computer screen, where the printed media or screen shot is well within the peripheral field of view of an evaluator. The Applicant discovered that by presenting the totem in such a format, an evaluator can gather sufficient information merely by a glance. Behavioral disposition indicia XB, B, MB, MP, P and XP, aid an evaluator or user in grasping the behavioral predisposition of the user with respect to orientations related to indicia ideation, risk, process and total. Behavioral disposition indicia No, Flex and Yes, aid an evaluator or user in grasping the behavioral predisposition of the user with respect to orientations related to indicia control, relationship and networking. Behavioral disposition indicia Concrete, Flex and Visionary, aid an evaluator or user in grasping the behavioral predisposition of the user with respect to orientations related to indicia input, flow, passion, output and networking.

The totem is the sum of iO and Innovation Orientation Modifiers (iOM). The iO shows the position along the full innovation continuum a person prefers or is predisposed to work. In other words, this is one's “sweet spot” when it comes to being innovative and is comprised of four unique “orientations” as follows:

Ideation—One's approach to the generation of new ideas.

Risk—One's approach to taking risks.

Process—One's approach to establishing and following process.

Total iO—Weighted summation of one's Ideation, Risk and Process Orientation.

The iOM shows indicators that “modify” how one approaches developing innovative ideas, how one seeks information, makes decisions, finds energy to generate ideas, works with others, and one's preferred action mode. The iOM is made up of eight unique “orientations” as follows and each of the three of the iOMs, i.e., “Control,” “Relationship” and “Networking” orientations is further presented as two attributes (line items) to result in a total of fifteen attributes: Control—One's approach to taking charge or allowing others to do so. “No” means that a person has no interest in controlling others. They are not all that interested in influencing the larger decision making process. “Flex” means that a person does not have strong preference on this characteristic. How the person responds depends on the situation. “Yes” means that a person prefers to be in control of projects when working with other people. The person tends to seek opportunities where he or she can oversee the work of others providing the necessary structure and decision making that will focus and guide the activities of others. The person seeks to influence the larger decision making process which is largely outside his or her direct control.

Relationship—One's approach to establishing personal relationships. With “I Initiate,” “No” means that a person does not prefer to reach out to get to know others. The person finds that too much self-disclosure is not comfortable for the person. The person tends to avoid conflict. “Flex” means that one does not have a strong preference on this characteristic; how one responds depends on the situation. “Yes” means that a person prefers to reach out to get to know others. It engages them both at head (intellectual) and heart (emotional) levels. This is important for them in developing the necessary level of trust required for them to be most effective, especially in risky situations. With “Others Initiate,” “No” means that a person prefers to be left alone except perhaps for a few close working relationships. One does not necessarily dislike others; one just prefers to maintain privacy. One is probably not comfortable disclosing personal information and does not expect it from others. “Flex” means that one does not have a strong preference on this characteristic; how one responds depends on the situation. “Yes” means that a person prefers to have others approach them to establish relationships.

Networking—One's approach to establishing and being part of social networks. With “I Initiate,” “No” means that a person prefers to be more selective in who the person does or does not include. One tends to avoid meetings that one finds exhausting. If one builds networks at all, it would be with only those people who can affect the person's success on his/her job or assigned activities. “Flex” means that one does not have a strong preference on this characteristic; how one responds depends on the situation. “Yes” means that a person prefers to have many contacts and acquaintances and one actively takes the lead to do this. One makes little distinction between work and social life. One wants to be “in the know” in terms of what's going on in his/her organizations and elsewhere. With “Others Initiate,” “No” means that a person prefers to be left alone to do his/her job or attend to his/her personal life. The person forms very few friendships. The person will tend to avoid being the center of attention. “Flex” means that one does not have a strong preference on this characteristic; how one responds depends on the situation. “Yes” means that a person prefers to be given the opportunity to attend social gatherings or meetings. One can feel snubbed if not invited. One prefers to give input to decisions that might affect him/her or others. One does not want to be caught unaware of things that could affect his/her work or his/her life.

Input—One's approach to seeking information. “Concrete” means that when learning, processing or seeking new information, one's preference is to focus on “sensory” data or things that are concrete. Information that is measurable is perceived as more quantifiable to one and will increase the likelihood of one's retention. When able to process details of a situation, one will be better positioned to build incrementally toward a big picture. “Can Flex” means that when seeking or processing information, one sometimes prefers to process specific details and at other times prefers beginning with the “Big Picture.” Situational cues will influence how one proceeds. Because one “can flex,” one possesses an ability to understand how those around one are also processing information and in turn one may be influenced by these group norms. “Visionary” means that “tell one his/her destination and one will FIG. out how to get there later.” As a visionary, one values seeing the entire forest before looking at the individual trees as one prefers to see the Big Picture. One's imagination and visions of “what could be” serve greater purpose to one than finite details or specific pieces of information when designing systems. If one will be putting forth significant energy toward an effort, one's preference is to first understand or make sense of its prime objective.

Flow—One's approach to pursuing divergence or convergence. “Converge” means that as a person whose preference is to converge, one is someone who loves to plan, schedule, hit all of one's timelines and cross them off one's list. One prefers to focus on a set of best practices or solutions that one feels will efficiently solve a problem. Once one has located a solution pathway that appears primed for success, one's preference is to steadily work toward a goal making it a reality without deviations or too many obstructions. “Can Flex” means that one possesses the ability to work toward a defined solution or keep one's options open depending on the circumstances. The situation one is in as well as the group one is engaged with will typically play a significant role in whether one converges or diverges when seeking solutions to problems. “Diverge” means that as someone prefers to diverge when problem solving. One will formulate as many ideas as possible when seeking a solution. One gains satisfaction from discovering various ways to approach a problem as much as solving the problem. One will tend to focus on concepts and ideas more than timetables or schedules. One likes to keep one's options open.

Passion—One's approach to taking action. “Prudent” means that as someone who is prudent, one's preference is to take the necessary time to thoroughly process the meaning and ramifications of a chosen course of action. One will not want to proceed if one feels enough time has not been spent to thoroughly review all the plusses and minuses and their probabilities for any chosen solution. When making strategic decisions, one may be seen by others as frugal or overly cautious. “Depends” means that when making a decision, one possesses the ability to quickly spring into action or takes as much time as needed to process the ramifications of a chosen course of action. The surrounding environment and people involved will play a significant role in how quickly one takes action. “Action” means that one's preference is to spring into action quickly once an idea or solution has been generated. It is in one's nature to accept that mistakes are part of the learning process and one will change problem solving strategy as necessary while one creates. Since one is likely to progress to action quicker than others, at times one may become impatient if things are not moving fast enough for him/her. Some may view the person as one who acts on impulse.

Output—One's approach to making decisions. “Heart” means that when solving a problem or making a decision, it is one's preference to consider its impact on the people involved. That is not to say one is not concerned with effectiveness and functionality of outcomes; but as one decides on a solution to a problem, there will be consistent concern expressed for how well a solution can and will be utilized by others. “Can Flex” means that as a person who can make a decision with either one's head and/or heart, the situation one is in or group one is involved with will have the greatest impact on whether one's decision-making approach is more logic or people-based. One's ability to flex to logic or values makes one a favorable candidate for consultation on many topic areas. “Head” means that one prefers to look at matters rationally when making decisions. Facts and logic are the inputs one seeks when assessing how to develop a solution. The people who will benefit from a decision or solution do matter but they are thought of second. As a person who makes decisions with his/her head, one finds satisfaction in delivering solutions that are functional and efficient.

Energy—One's approach to seeking energy to solve problems. “Self” means one is able to recharge when one is alone. When involved in a long stretch of intense activity with others, one can become extremely fatigued and needs to be by oneself for a while so that one's internal state can settle before reengaging with other people. One tends to process one's ideas while alone, often overnight. One appreciates it when others give him/her the time to be alone to process one's ideas as it allows one to fully leverage one's capacity to deeply reflect on things. “Can Flex” means that as a person who can flex on how one energizes and reflects on ideas, one does not have a strong preference as to whether one wants to be alone or with others. At times, the situation will be the greatest determinant of one's preference. “People” means that one is energized by being around other people. This is most clearly seen after a long stretch of intense activity that leaves one exhausted. During times such as these, one finds that being with people involved in a new activity is very energizing and replenishing. One tends to process one's thoughts and ideas in conversation with others and enjoys working with others on projects.

In general, “Builders” are predisposed to work within a given paradigm in an effort to do things better and thereby improve the overall effectiveness and efficiency of the organization. “Pioneers” are predisposed to break out of the current paradigm in an effort to do things differently and create something entirely new. The spectrum shown in FIG. 3 ranges from “Extreme Builder” to “Extreme Pioneer.” One's answer or relative position is indicated by a “human” symbol 32. In summary and referring again to FIG. 3, the two diverse poles can be “builder” and “pioneer,” “self initiate” and “others initiate,” “concrete” and “visionary,” “converge” and “diverge,” “prudent” and “action,” “heart” and “head” and “self” and “people.”

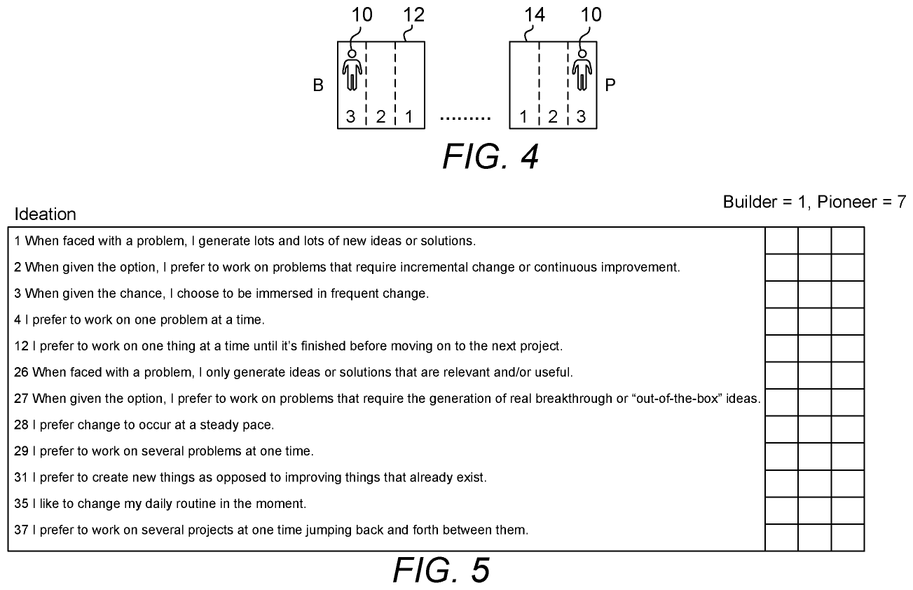

FIG. 4 depicts the representation of an individual's orientation in a totem. Each of the plurality of boxes further represents three discrete positions or subsections. It shall be noted that an individual's orientation is further represented in one of the three discrete positions, i.e., 1, 2 or 3 within a box 10. Each of these subsections represents about ⅓ of a standard deviation. All boxes are labeled relative to the midpoint or center of an orientation. For clarity, dotted lines are used to show the divisions of a box into the three discrete positions although such lines may not be depicted in a totem so as not to complicate interpretation of a totem. In this example, the individual's orientation as shown in the first box 12 is viewed as having a strong affinity to “B” as it is disposed in discrete position “3” or closer to “B” and the first box 12 is closer to “B” than it is to “P.” The individual's orientation as shown in the second box 14, on the other hand is viewed as having a strong affinity to “P” as it is disposed in discrete position “3” or closer to “P” and the second box 14 is closer to “P” than it is to “B.” Referring to both FIGS. 2 and 3, if an answer is a non-whole number, it would be represented in one of the subsections within a box based on the size of its decimal portion ranging from a small number on the left side of the box to a large number on the right side of the box. The Applicants discovered that the manner in which one's totem is presented is critical in the amount of information gained by an evaluator while he or she evaluates a totem. In one preferred embodiment, six boxes are used to represent an orientation. In another embodiment, three boxes are used to represent an orientation.

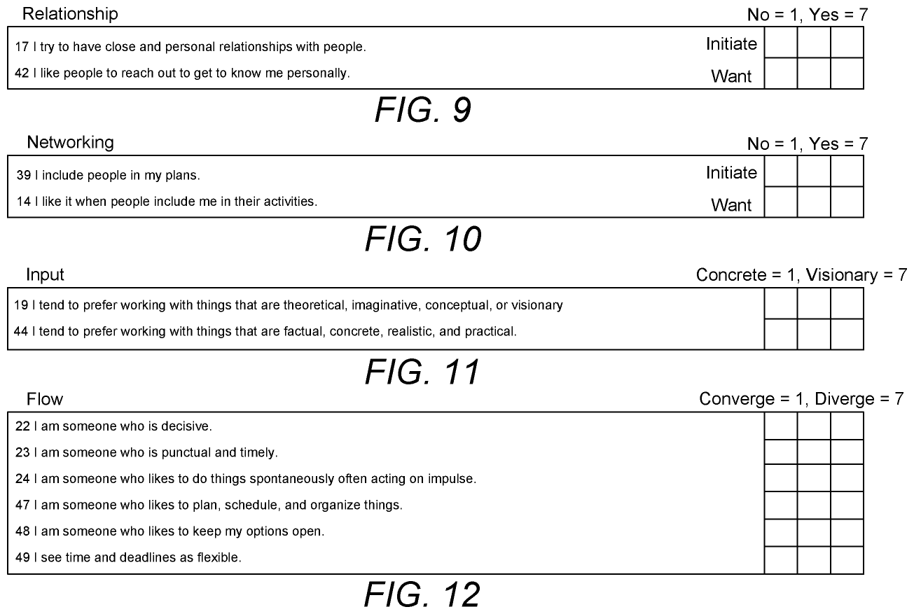

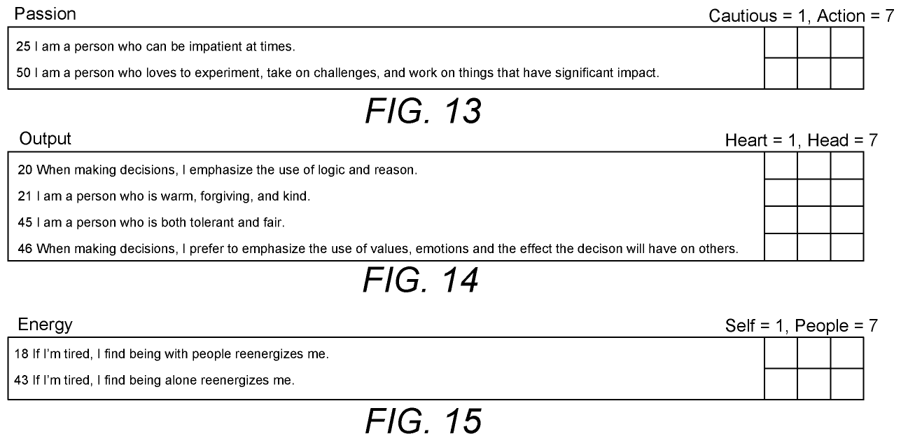

FIGS. 5-15 depict groups of questions totaling fifty questions which are used to generate a totem for an individual. FIG. 5 depicts a group of questions whose answers are used to result in a representation of an individual's orientation in terms of ideation. The numbers in the left-most column represent the order in which the questions are presented to a user out of a total of fifty questions, i.e., 1st, 2nd, 3rd, 4th, 12th, 26th, 27th, 28th, 29th, 31st, 35th and 37th. These questions are meant to the gauge the user's orientation with respect to ideation. For instance:

“1 When faced with a problem, I generate lots and lots of new ideas or solutions.”

“2 When given the option, I prefer to work on problems that require incremental change or continuous improvement.”

“3 When given the chance, I choose to be immersed in frequent change.”

“4 I prefer to work on one problem at a time.”

“12 I prefer to work on one thing at a time until it's finished before moving on to the next project.”

“26 When faced with a problem, I only generate ideas or solutions that are relevant and/or useful.”

“27 When given the option, I prefer to work on problems that require the generation of real breakthrough or “out-of-the-box” ideas.”

“28 I prefer change to occur at a steady pace.”

“29 I prefer to work on several problems at one time.”

“31 I prefer to create new things as opposed to improving things that already exist.”

“35 I like to change my daily routine in the moment.”

“37/prefer to work on several projects at one time jumping back and forth between them.

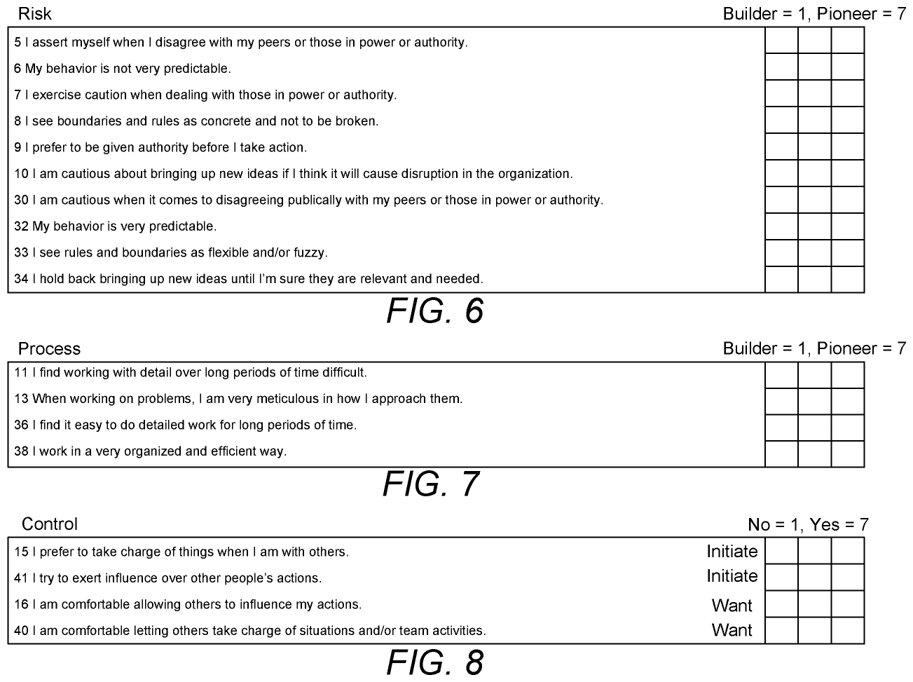

It shall be noted that questions are not presented in consecutive order from questions 1 through 50. The Applicant discovered that by obscuring the order of questions presented, a user may not discover a pattern to the questions and hence answer the questions in a rote manner. By taking an arithmetic average, the effects of inconsistent answers can be lessened. As another example, FIG. 6 depicts a group of questions whose answers are used to result in a representation of an individual's orientation in terms of risk. The order in which the questions are presented to a user is 5^{th}, 6^{th}, 7^{th}, 8^{th}, 9^{th}, 10^{th}, 30^{th}, 32^{nd}, 33^{rd} and 34^{th}. FIGS. 7, 8, 9, 10, 11, 12, 13, 14 and 15 depict a group of questions whose answers are used to result in a representation of an individual's orientation in terms of process, control, relationship, network, input, flow, passion, output and energy, respectively. Therefore, at least two questions of each of the plurality of groups of questions is presented in a non-consecutive manner to at least one other question of the plurality of groups of questions.

In the ensuing Figures, there is provided an example depicting a process by which to identify the best person for succession planning or replacement for a job. In this process, a theoretical ideal totem (archetype) is determined for the job, vetted and confirmed.

It shall be apparent from the ensuing example that the present system is a helpful tool to aid in the selection of a new candidate for a replacement position or to fill a position for an employee who is leaving a position. An ideal totem is created for the position based on the totem of the successful incumbent, interviews with coworkers and managers, and team discussion. The incumbent's totem and/or the ideal totem can be compared and evaluated against the totem of potential candidates. As an incumbent is leaving, a position needs to be filled. There are three candidates, i.e., Candidate #1 (first candidate), Candidate #2 (second candidate) and Candidate #3 (third candidate), for the position.

An ideal totem is determined by management with the understanding of the job to be vetted. An interview of the candidates is used to determine which traits are negotiable and which traits are non-negotiable. If possible, an interview is also conducted with the incumbent to determine which traits are negotiable and which traits are not. The ideal totem is compared with actual incumbent for the job. The candidates' orientations are then compared with the ideal totem for alignment. This is then followed by an interview with the incumbent person to help identify which ISPI orientations are negotiable and which are non-negotiable to help determine the best matching candidate. Key traits which produce success in the job being vetted are identified and an ideal totem is then produced. The totems of candidates are then compared to the ideal totem such that a candidate can be selected. If a perfect match of ISPI cannot be found in the existing candidates, it is possible to evaluate whether some traits are malleable or not. Upon matching totems, the skill base and values of the short listed candidate are then considered to ensure that the candidate will be a good fit.

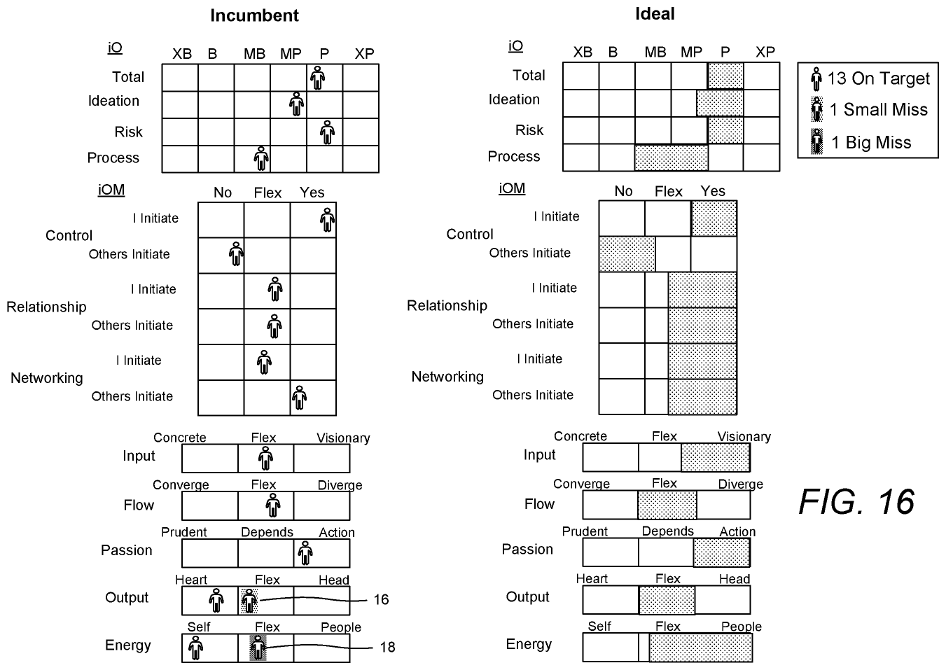

FIG. 16 depicts an example totem of an incumbent as compared to an example ideal totem. Discrepancies of the incumbent's totem from the totem to which it is compared, which in this case, is the ideal totem, is revealed. It shall be noted that thirteen of the fifteen attributes are considered on target while there is one small miss 16 and one big miss 18.

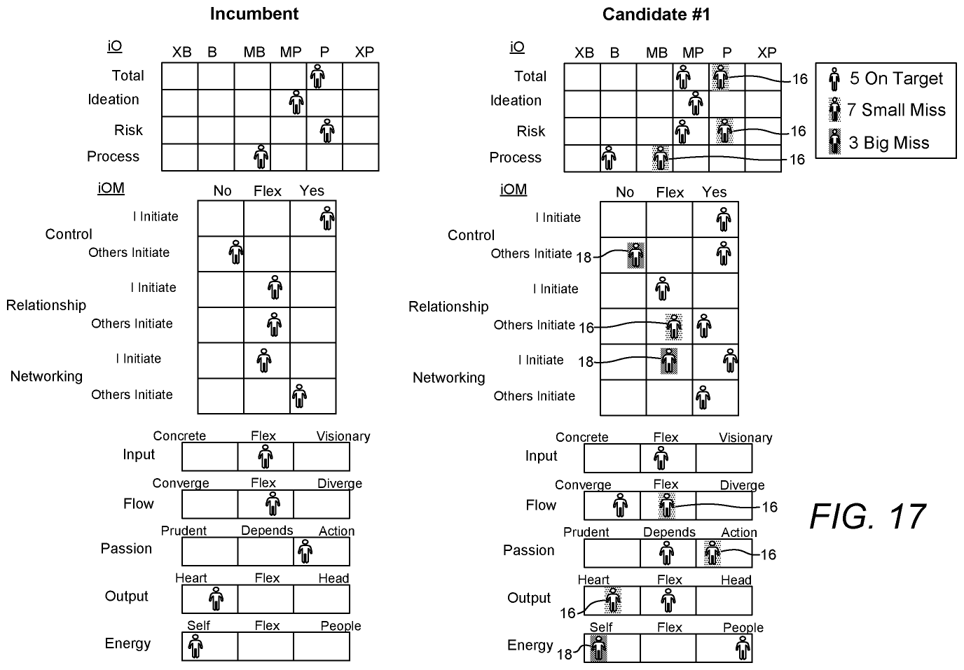

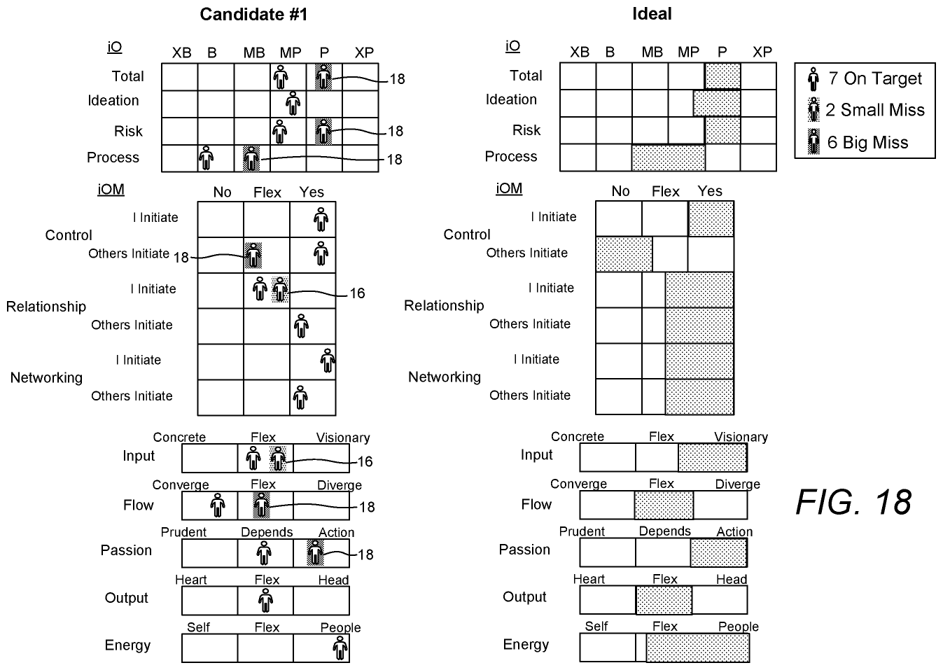

In one embodiment, the incumbent's totem is manually compared to the ideal totem. In another embodiment, the incumbent's totem is electronically compared with the ideal totem such that the gaps are automatically generated and superimposed upon the incumbent's totem to facilitate flagging of such discrepancies. In yet another embodiment, at least one criterion (e.g., no big misses) can be set such that only a totem which matches such criterion is considered. This is especially useful if a large number of totems are to be compared with an ideal totem. FIG. 17 depicts an example totem of an incumbent as compared to an example totem of a first candidate. The gaps indicate three big misses 18 as well as seven small misses 16. When compared to the ideal totem as shown in FIG. 18, the first candidate also shows significant misses including six big misses 18 and two small misses 16. A big miss, as used herein, represents a situation in which a survey taker's answer is more than three standard deviations away from a target or desired totemic position. Additionally, if an answer is disposed on an opposite side of a prominent behavioral-characteristic boundary, this would also be considered a big miss. A medium to small or small miss represents a situation in which a survey taker's answer is less than or equal to three standard deviations away from a target or desired totemic position. In one embodiment, the levels of misses are further color coded such that they may be more easily discerned. If desired, two totems may also be compared automatically by contrasting relative positions of each orientation. If a difference in relative positions exceeds a predetermined threshold, the difference is flagged.

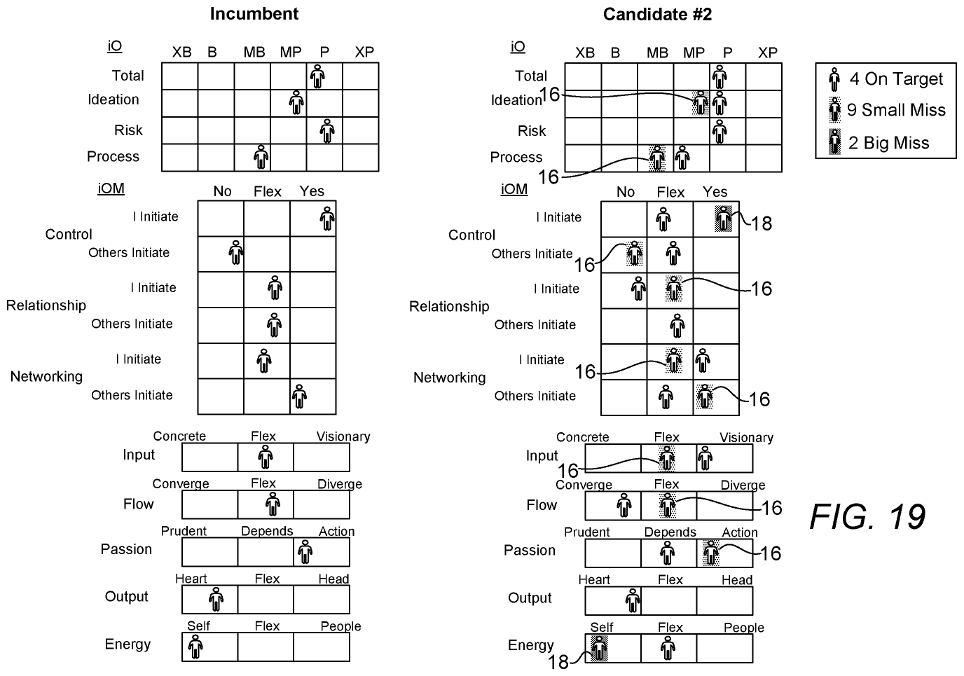

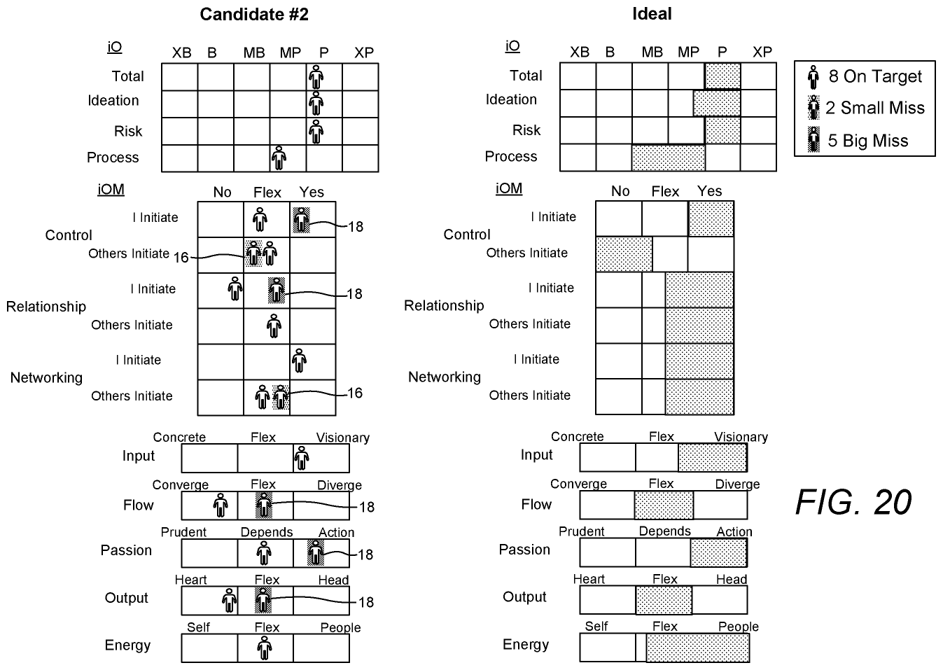

FIG. 19 depicts an example totem of an incumbent as compared to an example totem of a second candidate. When the incumbent's totem is compared with the second candidate's totem, there are two big misses 18 and nine small misses 16. FIG. 20 depicts an example totem of a second candidate as compared to an example ideal totem. Again, the second candidate's totem is significantly different than the ideal totem where there are five big misses 18 and two small misses 16.

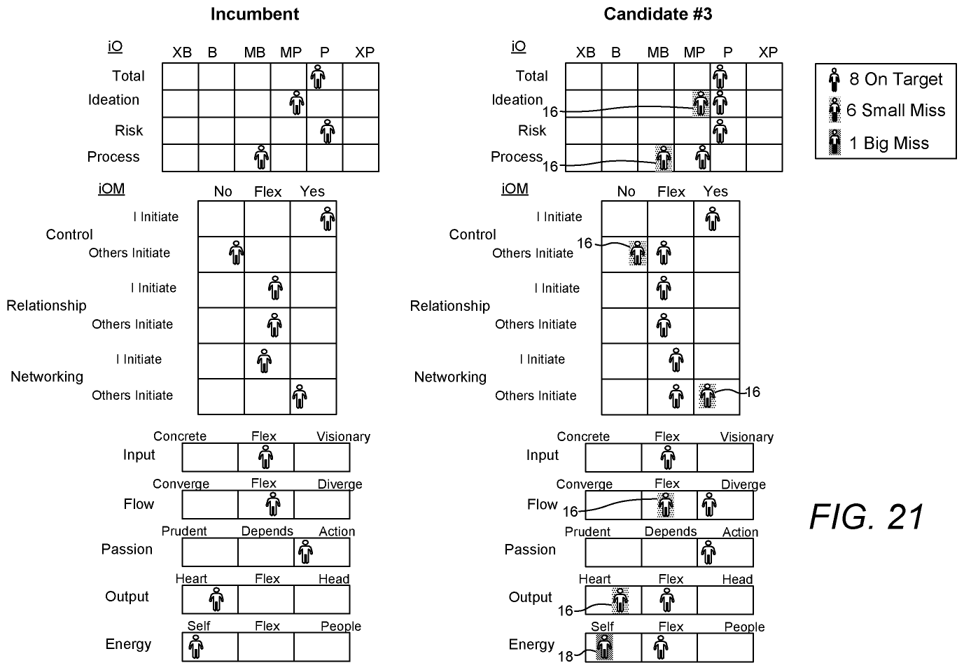

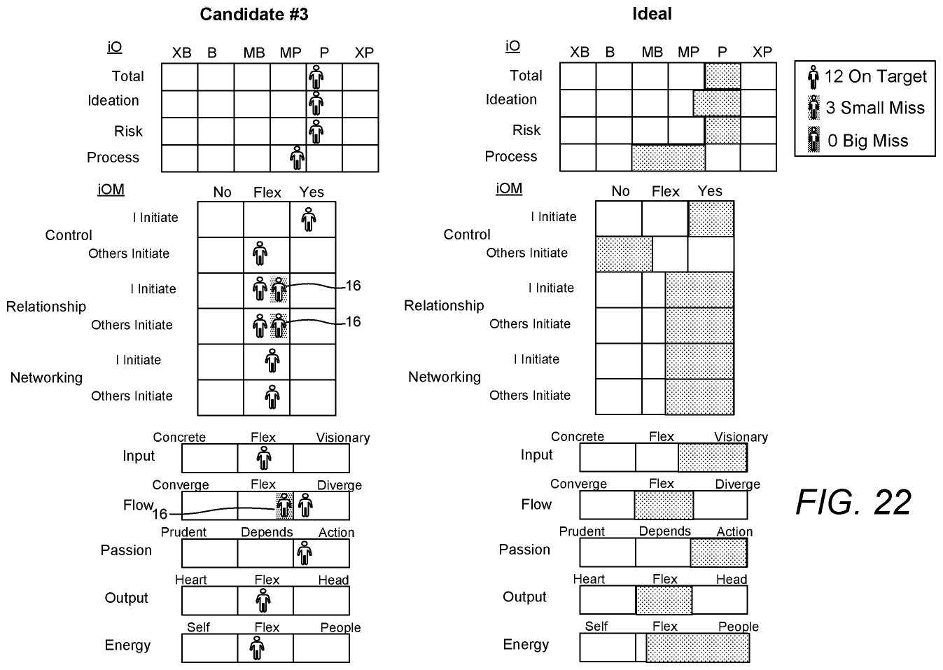

FIG. 21 depicts an example totem of an incumbent as compared to an example totem of a third candidate. When the incumbent's totem is compared with the third candidate's totem, there is only one big miss 18 and six small misses. FIG. 22 depicts an example totem of a third candidate as compared to an example ideal totem. Such comparison results in only three small misses 16 and no big misses 18. The third candidate therefore appears to be a more suitable candidate compared to the first and second candidates for the job to be filled as there are fewer big and small misses when compared to the ideal totem. In another embodiment not shown, in order to fill a position requiring an orientation complementary to an established totem, it is a matter of computationally or visually combining a candidate's totem with the established totem. For instance, if an established totem indicates that a current successful employee possesses only predictive indicators of behavior as an extreme pioneer in ideation and risk, the candidate having strong predictive indicators of behavior as an extreme builder in ideation and risk will be selected.

A Change Indicator Map (CIM) may further be provided. The means by which a CIM is produced is similar to that disclosed in FIGS. 16-22. However, instead of obtaining discrepancy data between the totem of an individual and an ideal totem, the discrepancies between a later-taken totem of a user and an earlier-taken totem is obtained to indicate differences in output parameters over time. A CIM provides a visual representation of the degree of change in an individual's orientation over time. In addition to indicating the existence of differences between two sets of output parameters, a CIM also indicates the degree of such differences. A CIM can be used to measure an individual's development as a result of coaching and training, or it can also measure the effects of stress conditions that the individual may have been experiencing events, e.g., a battle, the birth of a child, a grievous loss, etc.

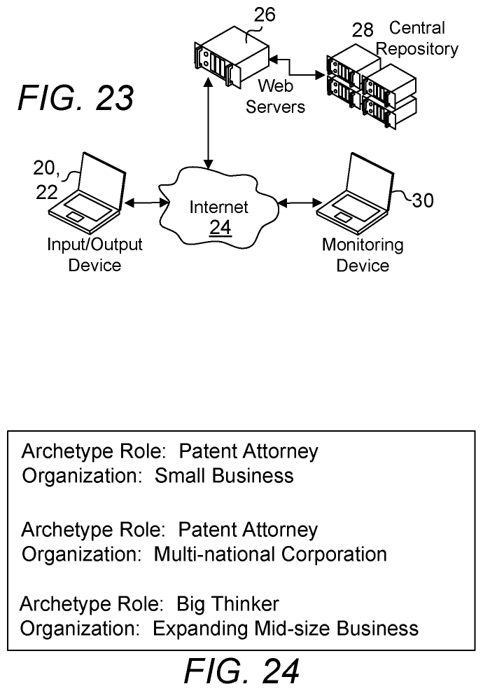

FIG. 23 is a block diagram depicting one embodiment of the hardware for carrying out the present system. The system includes an input/output device 20, 22, monitoring device 30, at least one web server 26 and a central repository 28, where all of these hardware communicate via the internet 24. A web application is provided in the input/output and monitoring devices 20, 22, 30 accessible to a user or a manager. As will be appreciated by those skilled in the relevant art(s) after reading the description herein, in an aspect, the web application of devices 20, 22, 30 execute on one or more web servers 26 providing one or more websites which send out web pages in response to Hypertext Transfer Protocol (HTTP) or Hypertext Transfer Protocol Secured (HTTPS) requests from remote browsers. Thus, such web servers 26 are able to provide a graphical user interface (GUI) to users of the input/output/monitoring devices 20, 22, 30 or other devices utilizing the web application of the web servers 26 in the form of web pages. These web pages are sent to the input/output and monitoring devices 20, 22, 30. An input, output or monitoring devices 20, 22, 30 may be any one of these devices: computing device, desktop computer, laptop computer, notebook computer, mobile device, smart phone, personal digital assistant (PDA), electronic pad or like terminal devices where a GUI screens is capable of being displayed.

In preparing the present system for use, user interfaces, questions and answer choices are first stored in a database of the central repository 28 via the monitoring device 30. A user account for a user can be created prior to the user accessing the interface or at the time the user is accessing the interface. Upon logging into the user account, the user can then access a GUI which presents questions and answer choices associated with the questions via the input device 20. An input device 20 may include a keyboard and mouse, etc., via which the user can then select answers to the questions. A web server subsequently stores the received answers in the central repository 28 for the user account. In one embodiment, the central repository 28 is a memory device. In one embodiment, each web server contains a processor and a resident memory device or a logic element that is functionally connected to the processor. The GUI may be stored in this resident memory device or the memory device of the central repository 28.

At an opportune time or upon the submission of the answers, the answers are processed in one or more web servers such that the user's totemic data is calculated and again stored in the central repository 28. As previously disclosed, it is also possible to make discrepancy data available. If desired, discrepancy data can be calculated by comparing the user's orientations with a respective ideal totem and store the differences in the central repository 28. Similarly, upon receiving answers from the user, an interested party or a manager may access answers previously provided by the user by retrieving the answers from the central repository 28. Ideal totems may also be stored in the central repository 28 or locally at the monitoring device 30 such that it can be retrieved and presented side-by-side with the user's totem on the monitoring device 30.

The manager may also choose to retrieve the discrepancy data from the central repository 28 and superimpose it on the user's totem on the monitoring device 30. If desired, the user may also view his/her totem on the input/output device 20, 22 such that the user can better understand his/her own orientations. In another embodiment not shown, the input/output device 20, 22 may be eliminated and replaced simply with the monitoring device 30 or the monitoring device 30 may be eliminated and replaced simply with the input/output device 20, 22. As the present system operates via the internet 24, its use is not limited to a particular locale or time. If desired, the present system may also be run as a stand-alone application from a computer.

Further disclosed is a method for narrowing a pool of candidates to fulfill at least one role in an organization. In fulfilling a new role in an organization or a firm, traditional interview and testing programs seek to evaluate and shortlist candidates based merely on their technical competency, “gut feel,” emotions and other subjective measures. In one embodiment, an archetype role is created in the form of a composite totem to aid in shortlisting candidates. FIGS. 24-37 illustrate a process by which a pool of candidates can be shortlisted by applying the present concept of ISPI orientations. FIG. 24 depicts examples of archetype roles one or more firms can seek to fill. Examples of archetype roles include, but not limited to, “patent attorney,” as sought by a small business, “patent attorney,” as sought by a multi-national corporation and “big thinker” as sought by an expanding mid-size business. It shall be noted that the same role, e.g., “patent attorney” may have different requirements for different organizations and organizations of different sizes, e.g., small business and multi-national corporation.

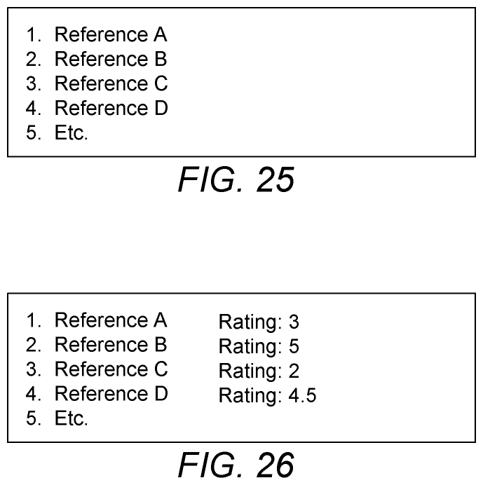

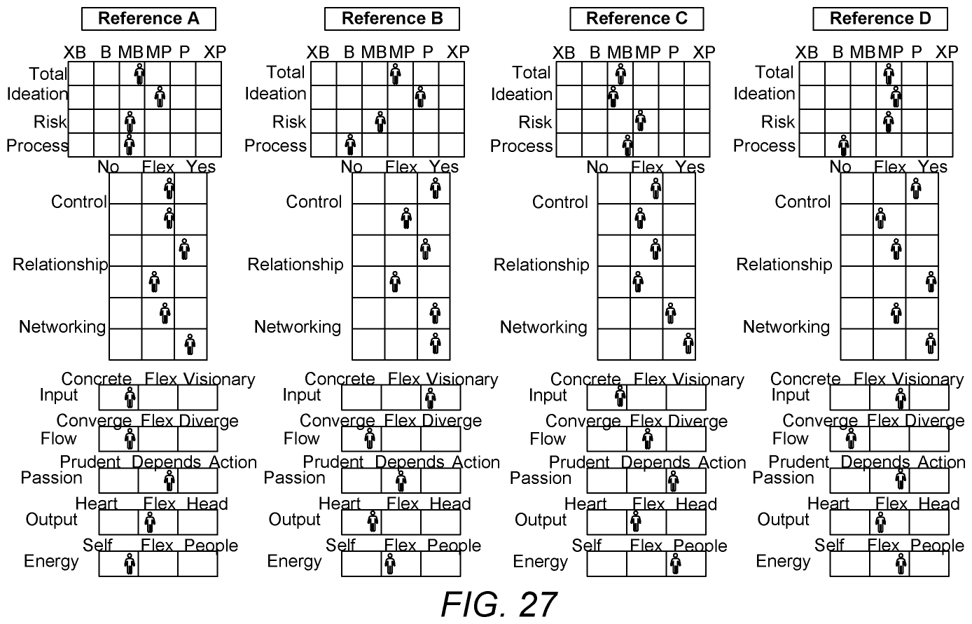

FIG. 25 depicts an exemplar set of individuals considered successful in the role a firm is attempting to fill. FIG. 26 depicts ratings provided by an executive team or manager of a firm of the exemplar set of individuals on how well the individuals match the role the firm is seeking to fill. An executive, executive team or manager, as used herein shall mean a party to which at least one individual of an exemplar set of individuals currently works for, reports to, or used to work for. The executive, executive team or manager is therefore intimately familiar with the orientation of at least one individual of an exemplar set of individuals. The exemplar set of individuals is proposed by one or more managers or executives having direct or indirect knowledge of two or more recommended individuals who they consider as successful in a role identical or similar to the role the firm of the managers or executives is seeking to fill. Each of the exemplar set of individuals is assigned as shown in FIG. 26, a rating by one or more managers or executives. If more than one rating is provided, e.g., by more than one manager or executive, of an individual, an average is used. FIG. 27 depicts totems collected from an exemplar set of individuals considered successful in the role a firm is attempting to fill. In one embodiment, all individuals of the exemplar set, regardless of their rating, are required to take an ISPI to create a totem. In another embodiment, only those individuals of the exemplar set who have been rated at a level higher than a predetermined threshold are required to take the test to create a totem. If any individuals of the exemplar set have previously taken the test, such record may be utilized without requiring new totems to be generated for those individuals.

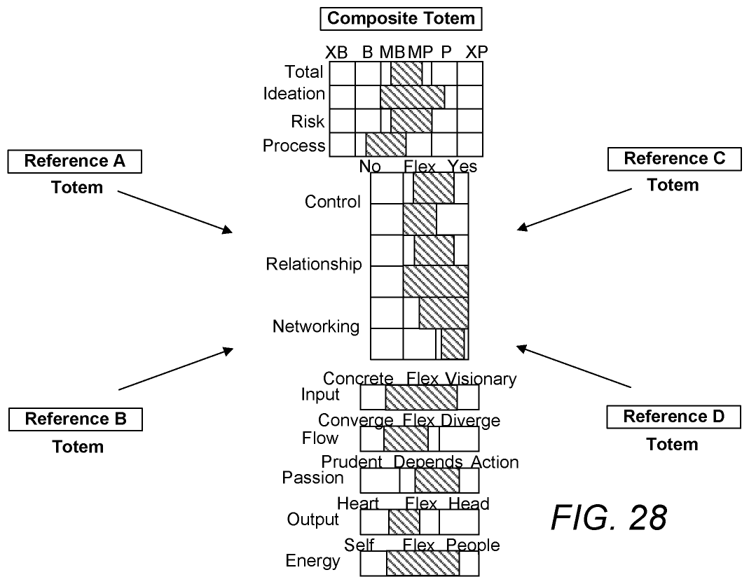

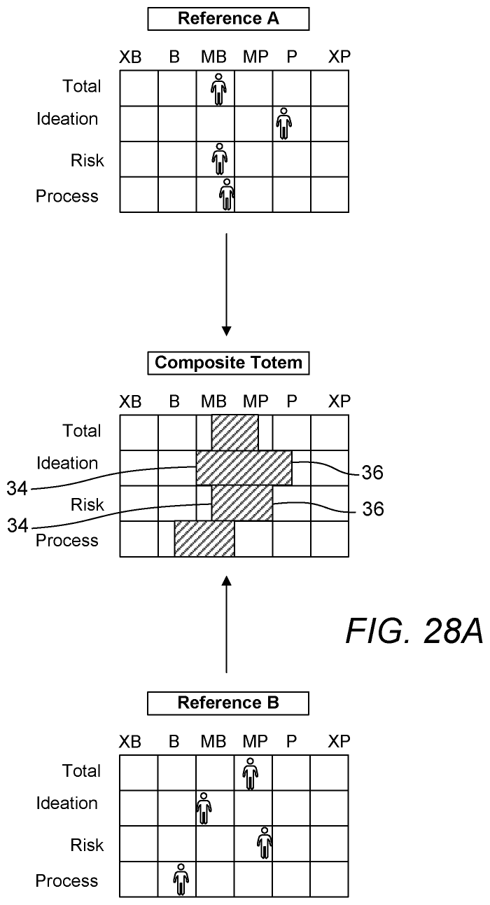

FIG. 28 depicts a composite totem that is the result of overlaying totems collected from an exemplar set of individuals considered successful in the role a firm is attempting to fill. For instance, if the positions of the output parameters of the composite totem are the result of two individuals and the first individual's output parameter is disposed at position “1” of “MB” and the second individual's orientation is disposed at position “3” of “MP,” the output parameters for the orientation of this archetype role ranges from position “1” of “MB” to position “3” of “MP.” In other words, the act of “overlaying” is configured to yield a composite output parameter inclusive of the output parameters of the totems of the two favorable individuals and a gap between the output parameters of the totems of the two favorable individuals for each predictive indicator. In the embodiment shown in FIG. 28, the totems of all individuals, regardless of their rating, are used to form a composite totem. FIG. 28A is a partial composite totem illustrating the result of overlaying two partial totems collected from an exemplar set of individuals considered successful in the role a firm is attempting to fill. It shall be noted that the range of each orientation shown in the composite totem is bounded by the orientations indicated in both Reference A and Reference B. For instance, the lower bound 34 of the orientation range corresponding to ideation is provided by Reference B and the upper bound 36 of the orientation range corresponding to ideation is provided by Reference A. Conversely, the lower bound 34 of the orientation range corresponding to risk is provided by Reference A and the upper bound 36 of the orientation range corresponding to ideation is provided by Reference B.

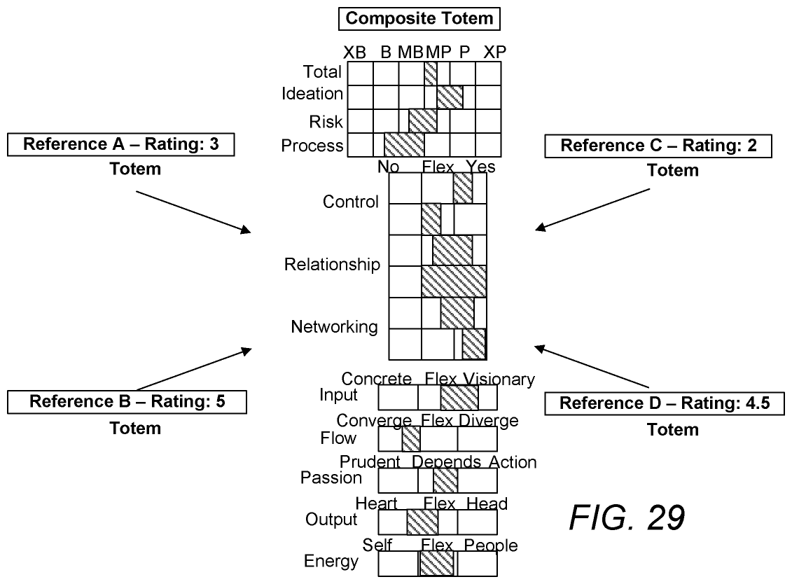

FIG. 29 depicts a composite totem that is the result of overlaying totems collected from top rated individuals of an exemplar set of individuals considered successful in the role a firm is attempting to fill. In this embodiment, only the totems of those individuals who have been rated at a level higher than a predetermined threshold are used to form a composite totem.

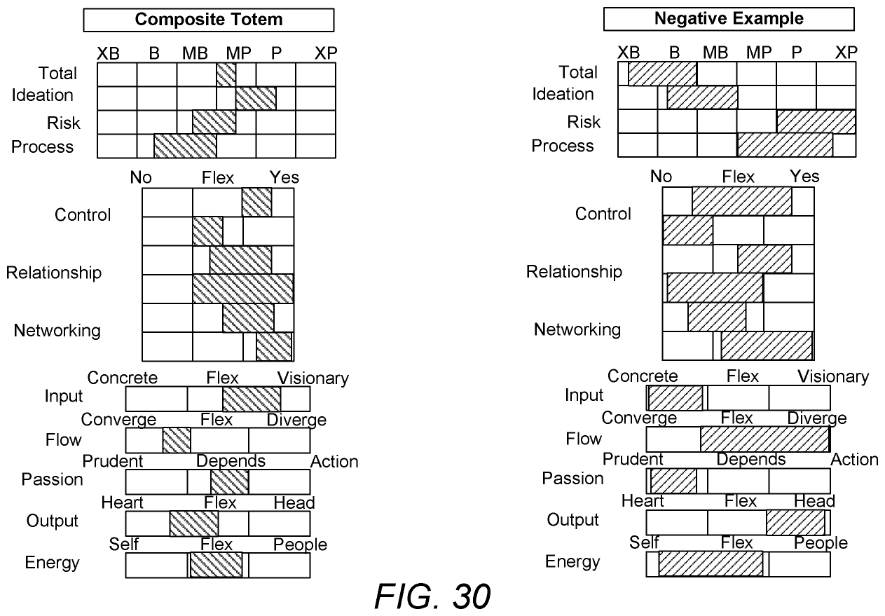

FIG. 30 depicts negative constraints represented in a composite totem that is the result of overlaying totems collected from individuals who are considered to not perform well in a role a firm is attempting to fill. In another embodiment, the negative constraints are traits determined independently by the managers and executives as being unfavorable. Such constraints may be applied to remove candidates considered for the role to be filled.

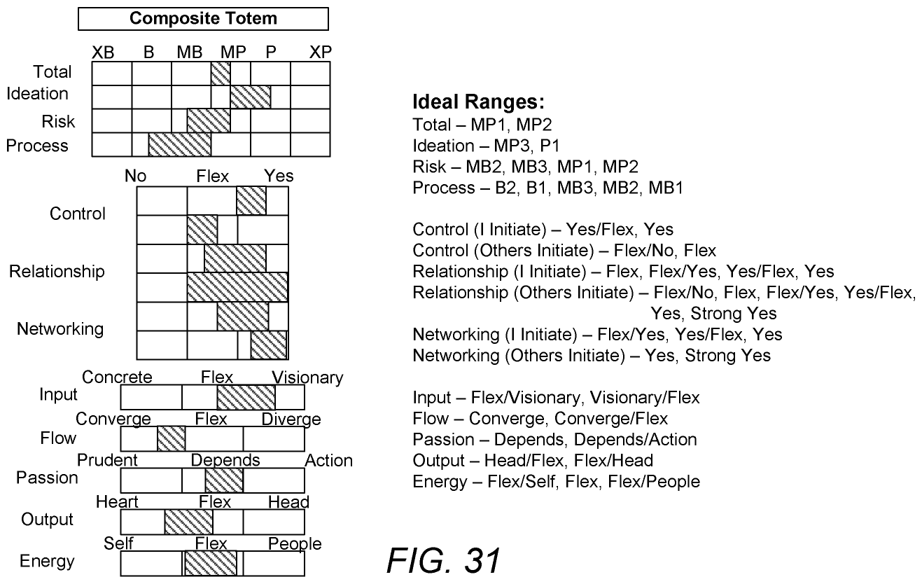

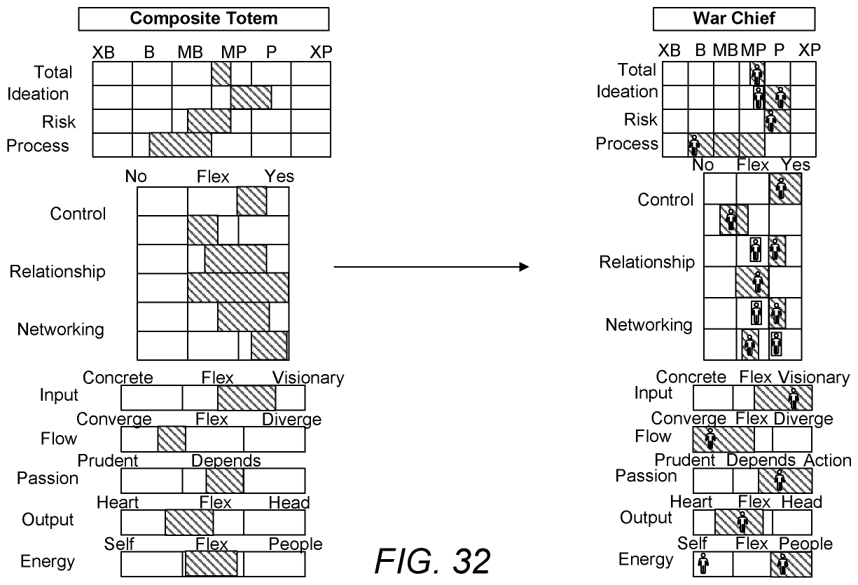

In one embodiment, a candidate who had previously been considered for a role and who had been compared against an existing ISPI archetype may be reconsidered for the role. FIG. 31 depicts ideal ranges for each of the ISPI orientations based on a totem for an exemplar set of individuals considered successful in the role a firm is attempting to fill. FIG. 32 depicts a comparison of the ISPI ranges of an exemplar set against an existing ISPI archetype to determine if the role a firm is attempting to fill can be filled by an individual who fits the existing ISPI archetype. For instance, a totem considered to belong to an individual viewed as a “War Chief” is compared to the composite totem created for an exemplar set of individuals considered successful in the role a firm is attempting to fill. Therefore, the shortlist of candidates may include an internal candidate or a candidate who is already assuming a different role in a firm. As such, the shortlisted candidates may include internal or external candidates. Internal candidates include candidates who are already part of the firm or any candidates whose orientations have already been obtained previously and matched with an existing archetype. Outside candidates include candidates who are not already part of the firm or any candidates whose orientations have not already been obtained previously or have not been matched with an existing archetype.

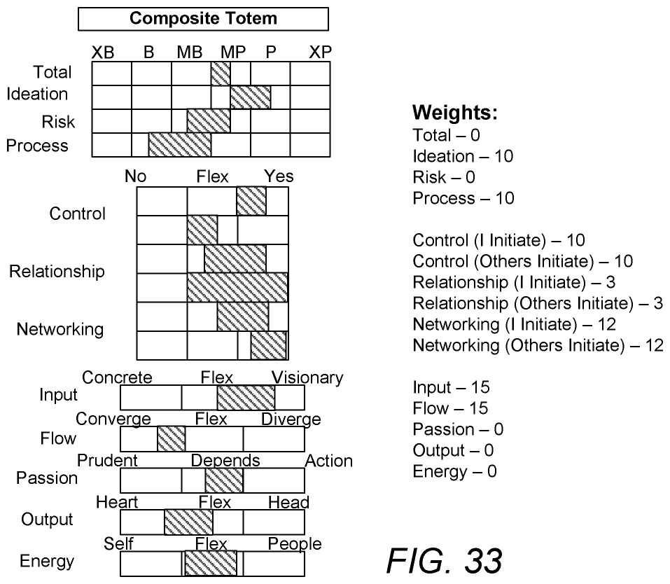

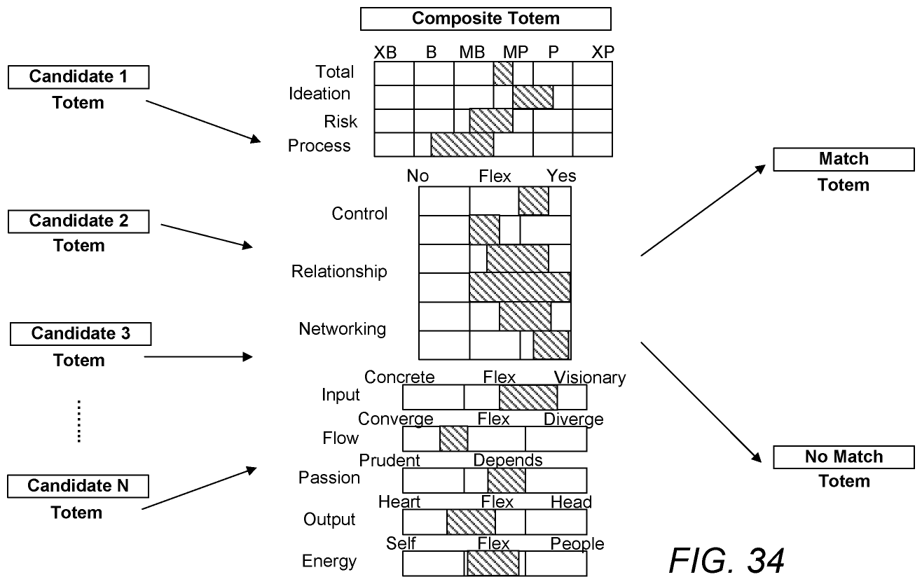

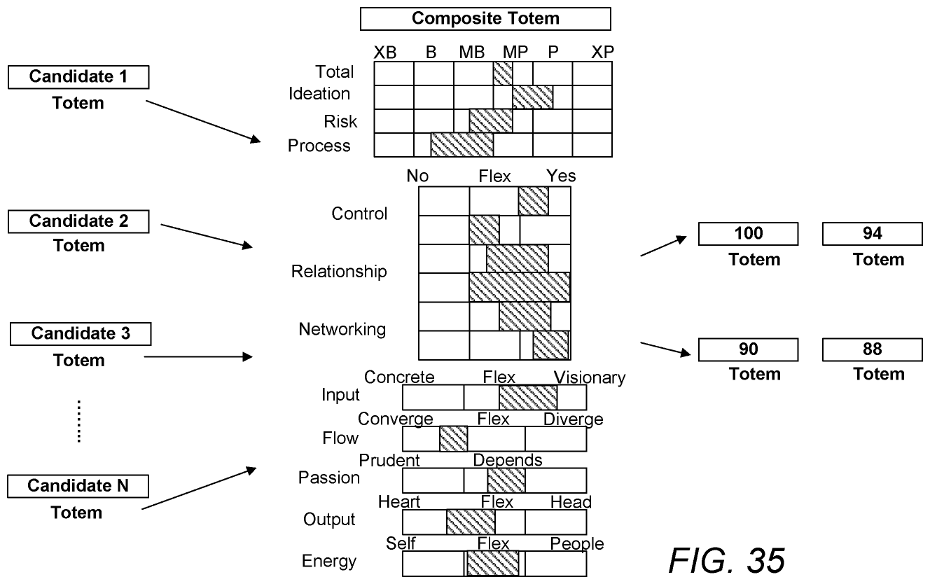

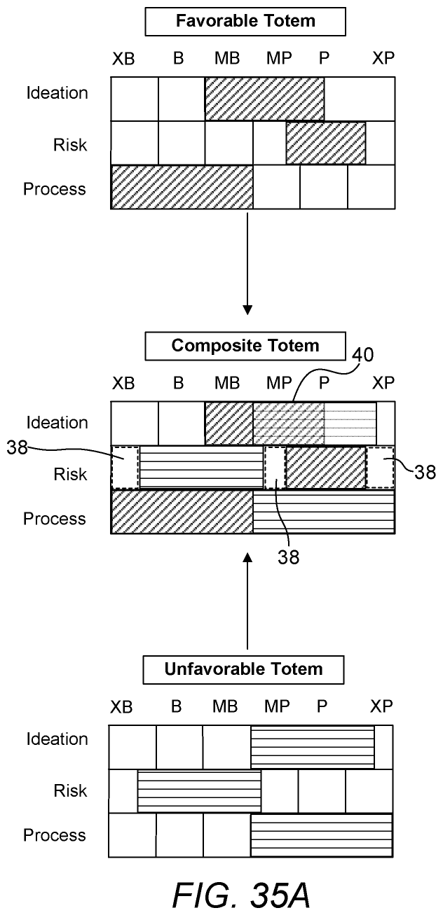

In one embodiment, the use of an archetype role is capable of refinement as shown in FIGS. 33 and 34. FIG. 33 depicts weighting of ISPI orientations based on their relevance to the role a firm is attempting to fill. FIG. 34 depicts a comparison of totems from potential candidates for the role a firm is attempting to fill to an ideal totem. For instance, on a scale of 100 points, 10 points is assigned to the indicium “ideation” and 10 points is assigned to the indicium “process,” while 0 points is assigned to the indicium “risk.” Therefore when compared to an archetype totem, if the “ideation” orientation of a candidate falls within the range of the corresponding archetype orientation, the contribution of this orientation of the candidate to the total score is 10. Although the “risk” orientation may also match, the contribution of this orientation of the candidate to the total score is 0 as it is assigned no weight. Comparisons of the archetype totem and totems of candidates and scoring of the candidates' totems may be carried out in a number of other ways. As long as comparisons are made on identical basis for all candidates, the results of such comparisons may be relied upon. FIG. 35 depicts a result of scoring each potential candidate for the role a firm is attempting to fill using weighting of ISPI orientations and negative constraints to arrive at a numerical indicator of how closely a potential candidate is in line with the expectation for the role a firm is attempting to fill. It shall be noted that weighting may be applied to negative constraints just as it can be assigned to ISPI orientations. For instance, if the indicium “ideation” is assigned—10 points for a match to a negative constraint of this indicium, a candidate having a trait falling within this negative constraint will have 10 points deducted from the total score. A match with any one of the negative constraints may also be treated as “deal breaker.” For instance, any one of the traits of a candidate with a negative constraint will remove the candidate from being considered for the role to be filled. In another embodiment, negative constraints are used in combination with a composite totem taken of an exemplar set of individuals as shown in FIG. 35A. FIG. 35A is a partial composite totem illustrating the result of overlaying two partial totems, one collected from an exemplar set of individuals considered successful in the role a firm is attempting to fill and the other collected from individuals known to managers or executives as not having performed well in the role to form a third totem. Only three orientations for two contributing totems are shown. Three scenarios are depicted in FIG. 35A. In the first scenario as shown in the orientation for ideation, when overlaid upon one another, the two partial totems result in an area of overlap 40, indicating that both totems, although drawn from two diverse groups of individuals, can show shared traits for a certain orientation. In the second scenario as shown in the orientation for risk, it shall be noted that the two partial totems result in no overlaps, with each occupying its own range on the risk spectrum and leaving areas not covered by any one of the ranges. Such uncovered areas 38 represent traits not present in the two totems. In the third scenario as shown in the orientation for process, it shall be noted that the two partial totems result in no overlaps, but leaving no uncovered areas. In one embodiment, weighting of orientations is based on whether or not the ranges of the two totems overlap, which differs from the case shown in FIG. 33 where each orientation is assigned a weight regardless of the areas of overlap or areas not covered. For instance, the area exerted by the totem taken from an exemplar set of individuals not overlapped assigned a first weight of the largest magnitude, the overlapped area may be assigned a second weight that is smaller than that of the first weight, the area exerted by the unfavorable totem that is otherwise not overlapped with an area exerted by the totem taken from an exemplar set of individuals assigned a negative value, the uncovered area 38 assigned a value of zero. Upon assigning weighting to each area, the total score of a candidate can be calculated based on the area within which an orientation of the candidate falls. For instance, if an orientation of a candidate falls within an overlapped area, 5 points may be added for the candidate while an orientation falling within an area exerted by the totem taken from an unfavorable totem may have 10 points deducted from the total score and an orientation falling within an area exerted by the totem taken from a favorable totem that is not overlapped with the totem taken from an unfavorable totem may have 10 points added to the total score. In yet another embodiment where negative constraints are not considered, scoring is performed much the same way as the process described in FIG. 35A, except without any consideration of negative constraints. By assigning different weights to various parts of the orientations of the third totem, the traits of a candidate can be objectively scored and compared to the traits of other candidates.

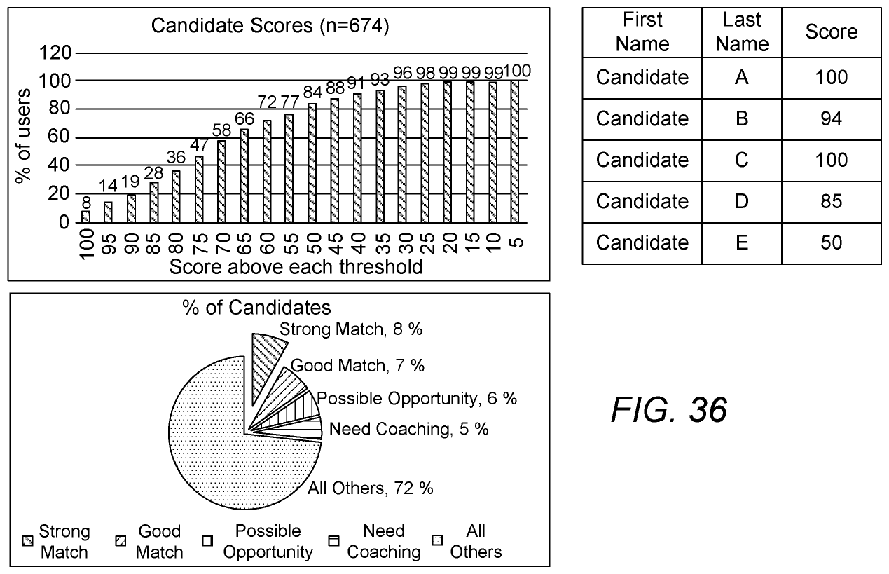

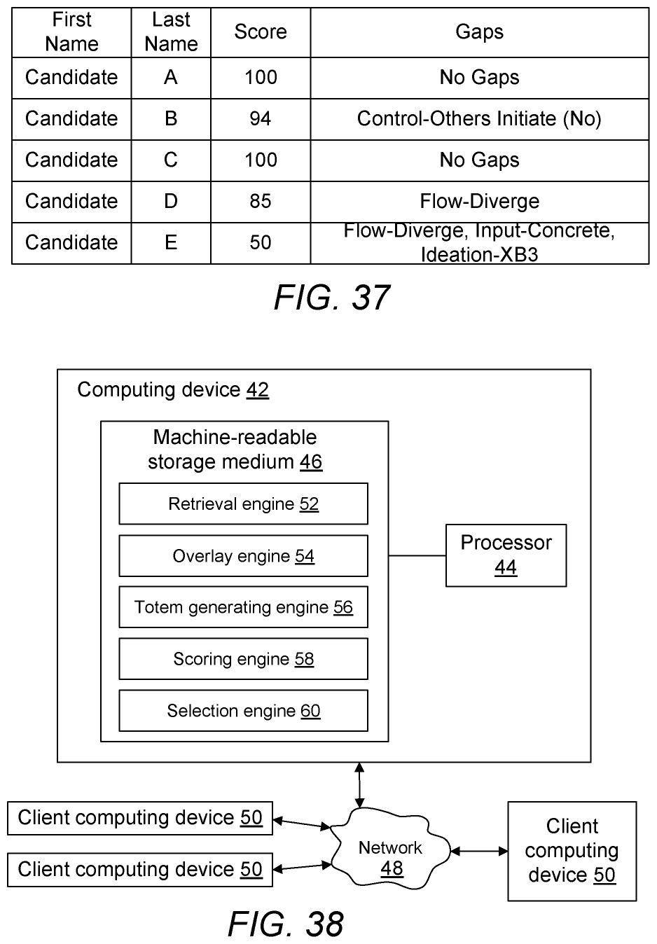

FIG. 36 depicts examples of reports indicating the suitability of potential candidates with respect to the role a firm is attempting to fill. FIG. 37 depicts gaps identified in potential candidates with respect to the role a firm is attempting to fill which can be used to further question or coach the potential candidates. Armed with such information, managers or executives will have an opportunity to get an overall view of the suitability of the pool of candidates in relation to filling the role. Generally, the top scorers are identified as those who may be able to fulfill the role a firm is attempting to fill. However, there may be an exception if a candidate who did not score as high as another candidate in archetype matching is able to start taking on the role immediately. If timeliness in accepting a role is important, consideration may be made to accommodate the candidate with the lower score and the candidate with the lower score may be selected in lieu of the more highly scored candidate. In general, however, and lacking external factors, the candidate with the top score will be selected. If more than one candidate is top scored, external factors can be used to select the right candidate for the role.

Working teams may be created by identifying a combination of archetypes that fit with specific types of projects. For example, in order to create a new product, archetypes that are more visionary-based would be desired while the duty to sustain a growing operation would require more methodical archetypes. Another example would be in partnering top executives with complementary mental model profiles so that the oversight of a company is balanced to include both the creative/visionary aspects and the practical/methodical aspects. In this way, archetypal combinations can be used to map the potential gaps on a team or leadership entity.

FIG. 38 is a block diagram of an example computing device for narrowing a pool of candidates for at least one role using methodologies disclosed elsewhere herein. Computing device 42 may comprise storage media for totems, e.g., one or more arrays of magnetic disk drives, solid state drives, optical, magneto-optical, or electro-optical storage media, storage media configured to implement RAID redundancy, cloud-based storage, storage media capable of handling big data, and/or other types of storage suitable for executing the functionality described below. In the example depicted in FIG. 38, computing device 42 includes a non-transitory machine-readable storage medium and a processor 44.

Processor 44 may be one or more central processing units (CPUs), microprocessors, and/or other hardware devices suitable for retrieval and execution of instructions stored in machine-readable storage medium. Processor 44 may fetch, decode, and execute program instructions to narrowing a pool of candidates for at least one role, as described below. As an alternative or in addition to retrieving and executing instructions, processor 44 may include one or more electronic circuits comprising a number of electronic components for performing the functionality of one or more instructions. In one example, the program instructions can be part of an installation package that can be executed by processor 44 to implement the functionality described herein. In this case, machine-readable storage medium may be a portable medium such as a Compact Disc (CD), Digital Versatile Disc (DVD), flash drive or a memory maintained by a computing device from which the installation package can be downloaded and installed. In another example, the program instructions may be part of an application or applications already installed on computing device 42.

Machine-readable storage medium may be any hardware storage device for maintaining data accessible to computing device 42. For example, machine-readable storage medium may include one or more hard disk drives, solid state drives, tape drives, and/or any other storage devices. The storage devices may be located in computing device 42 and/or in another device in communication with computing device 42. For example, machine-readable storage medium may be any electronic, magnetic, optical, or other physical storage device that stores executable instructions. Thus, machine-readable storage medium may be, for example, Random Access Memory (RAM), an Electrically-Erasable Programmable Read-Only Memory (EEPROM), a storage drive, an optical disc, and the like. As described in detail below, machine-readable storage medium may be encoded with executable instructions for narrowing a pool of candidates for at least one role. As detailed below, storage medium may maintain and/or store the data and information described herein.

Computing device 42 may include a series of engines 46-60 for narrowing a pool of candidates for at least one role. Each of the engines may generally represent any combination of hardware and programming. For example, the programming for the actions may be processor executable instructions stored on a non-transitory machine-readable storage medium and the hardware for the engines may include at least one processor of the computing device 42 to execute those instructions. In addition or as an alternative, each engine may include one or more hardware devices including electronic circuitry for implementing the functionality described below.

Upon receiving a recommendation from at least one manager of at least two favorable individuals, a retrieval engine 52 retrieves a totem that has been previously obtained of each of the favorable individuals. An overlay engine 54 overlays totems of favorable individuals to yield a composite totem representing a favorable archetype. A totem generating engine 56 obtains a totem from each candidate of a pool of candidates, e.g., by administering the totem generating process to the candidates. A scoring engine 58 scores the totems of the pool of candidates against the composite totem representing a favorable archetype and the selection engine 60 identifies at least one of the top scorers for further consideration to fill the at least one role. The computing device 42 may be part of a system that comprises client computing devices 50 that may be communicably coupled via a network 48, e.g., the internet. The network 48 may be any wired, wireless and/or other type of network via which the computing devices 42, 50 may communicate. Client computing devices 50 may comprise computing devices of users, administrators, and/or other entities. In some examples, client computing devices 50 may comprise functionality similar to computing device 42 and may be used by users, administrators, and/or other entities to receive totems, generate totems, operate on one or more totems, score individuals and/or otherwise interact with one or more totems or users, e.g., for purposes of administering a totem collection process and receiving recommendations from a manager, etc.

The detailed description refers to the accompanying drawings that show, by way of illustration, specific aspects and embodiments in which the present disclosed embodiments may be practiced. These embodiments are described in sufficient detail to enable those skilled in the art to practice aspects of the present invention. Other embodiments may be utilized, and changes may be made without departing from the scope of the disclosed embodiments. The various embodiments can be combined with one or more other embodiments to form new embodiments. The detailed description is, therefore, not to be taken in a limiting sense, and the scope of the present invention is defined only by the appended claims, with the full scope of equivalents to which they may be entitled. It will be appreciated by those of ordinary skill in the art that any arrangement that is calculated to achieve the same purpose may be substituted for the specific embodiments shown. This application is intended to cover any adaptations or variations of embodiments of the present invention. It is to be understood that the above description is intended to be illustrative, and not restrictive, and that the phraseology or terminology employed herein is for the purpose of description and not of limitation. Combinations of the above embodiments and other embodiments will be apparent to those of skill in the art upon studying the above description. The scope of the present disclosed embodiments includes any other applications in which embodiments of the above structures and fabrication methods are used. The scope of the embodiments should be determined with reference to the appended claims, along with the full scope of equivalents to which such claims are entitled.

What is claimed herein is:

1. A system for narrowing a pool of candidates for at least one role, wherein a totem is obtained from each individual of at least two favorable individuals for the at least one role, each totem comprises a plurality of output parameters each presented in a discrete scale representing a spectrum of the two diverse poles in a plurality of boxes, each said output parameter identifies a predictive indicator of an individual's neural predisposition for a behavior orientation of the individual, said system comprising:
(a) a processor; and
(b) a non-transitory machine-readable storage medium storing instructions that when executed, cause said processor to:
(i) responsive to receiving a recommendation from at least one manager of the at least two favorable individuals, retrieve a totem of each individual of the at least two favorable individuals;
(ii) overlay said totems of the at least two favorable individuals to yield a composite totem representing a favorable archetype, wherein said overlay act is configured to yield a composite output parameter inclusive of the output parameters of the totems of the at least two favorable individuals and any gaps between the output parameters of the totems of the at least two favorable individuals for each predictive indicator;
(iii) obtain a totem from each candidate of the pool of candidates;
(iv) score said totems of the pool of candidates against said composite totem representing a favorable archetype; and
(v) identify at least one of the top scorers for further consideration to fill the at least one role.

2. The system of claim 1, wherein each of the at least two favorable individuals comprises a rating.

3. The system of claim 2, wherein only any individuals of the at least two favorable individuals having said rating above a predetermined threshold is retrieved.

4. The system of claim 1, wherein said totems of said pool of candidates are scored against said composite totem representing a favorable archetype by weighting one or more output parameters of said totems of said pool of candidates.

5. The system of claim 1, wherein a totem is further obtained from each individual of at least two unfavorable individuals for the at least one role, wherein the non-transitory machine-readable storage medium storing instructions that when executed, further cause said processor to:
(a) responsive to receiving a recommendation from at least one manager of the at least two unfavorable individuals, retrieve a totem from each individual of the at least two unfavorable individuals;
(b) overlay the totems of the at least two unfavorable individuals to yield a second composite totem representing an unfavorable archetype, wherein said overlay act of this claim is configured to yield a composite output parameter inclusive of the output parameters of the totems of the at least two unfavorable individuals and any gaps between the output parameters of the totems of the at least two unfavorable individuals for each predictive indicator;
(c) overlay said second composite totem and said composite totem representing a favorable archetype to create a third composite totem comprising one or more conditions selected from the group consisting of an area not overlapped that represents said favorable archetype, an overlapped area of said favorable and unfavorable archetypes, an uncovered area and an area not overlapped that represents said unfavorable archetype in one or more predictive indicators;
(d) apply weighting to one or more predictive indicators of said third totem, wherein at least one of said area not overlapped that represents said favorable archetype is assigned a first weight, said overlapped area of said favorable and unfavorable archetypes is assigned a second weight, said uncovered area is assigned a third weight and said area not overlapped that represents said unfavorable archetype is assigned a fourth weight; and
(e) replace said score act with an act that scores said totems of said pool of candidates against said third composite totem.

6. The system of claim 1, wherein a totem is further obtained from each individual of at least two unfavorable individuals for the at least one role, wherein the non-transitory machine-readable storage medium storing instructions that when executed, further cause the processor to:
(a) responsive to receiving a recommendation from at least one manager of at least two unfavorable individuals, retrieve a totem from each individual of the at least two unfavorable individuals, wherein the at least two unfavorable individuals are mutually exclusive from the at least two favorable individuals;
(b) overlay the totems of the at least two unfavorable individuals to yield a second composite totem representing an unfavorable archetype, wherein said overlay act of this claim is configured to yield a composite output parameter inclusive of the output parameters of the totems of the at least two unfavorable individuals and any gaps between the output parameters of the totems of the at least two unfavorable individuals for each predictive indicator; and
(c) apply said second composite totem representing an unfavorable archetype to said identify act, whereby if said at least one of the top scorers has an orientation falling within predictive indicator ranges of said second composite totem representing an unfavorable archetype, said at least one of the top scorers is rejected from consideration from filling the at least one role.
